(19) United States
(12) Patent Application Publication
(10) Pub. No.: US 2008/0235980 A1
(43) Pub. Date: Oct. 2, 2008

(54) CENTRIFUGAL SPRAYER AND HAIR DRYER HAVING THE SAME FOR APPLICATION OF A HAIR TREATMENT LIQUID

(75) Inventors: James E. Chasen, West Haven, CT (US); Gary Lee McMurray, Verona, WI (US); Charles Edward Quinn, Sun Prairie, WI (US)

Correspondence Address: Christopher M. Goff (27840);ARMSTRONG TEASDALE LLP, ONE METROPOLITAN SQUARE, SUITE 2600, ST. LOUIS, MO, 63102, US

(73) Assignee: Rovcal, Inc., Madison, WI (US)

(21) Appl. No.: 11/693,879

(22) Filed: Mar. 30, 2007

(51) Int. Cl. F26B 19/00; A45D 20/08; B65D 85/68

(52) U.S. Cl. 34/91; 206/320; 34/96

(57) ABSTRACT

A hand held personal care appliance, such as a hair dryer, has a liquid delivery system for delivering a spray of liquid from the appliance. The liquid delivery system has a reservoir for containing a supply of liquid and a liquid transfer system. A rotatable drum has a surface in fluid communication with the liquid transfer system for receiving liquid onto the surface of the drum. A drive system rotates the drum such that the liquid is thrown from the drum by centrifugal force of the rotating drum for delivering liquid from the appliance in the form of a spray of droplets. In some embodiments, the fluid transfer system includes a first wick for delivery of the liquid to the drum and a second wick for delivery of liquid to the first wick. The reservoir and other parts of the liquid delivery system may be a disposable cartridge.

### FIELD OF INVENTION

The present invention relates generally to hand held personal care appliances and more particularly to personal care appliances such as hair care appliances including hair dryers, curling irons, hair straighteners, clippers, trimmers and the like, and to facial or body hair care appliances such as shavers, having liquid delivery systems for delivering a treatment liquid to a subject's hair or skin.

### BACKGROUND

Various hair and/or skin treatment products are available for use in treating one's hair or skin. For example, in the arena of hair care products a wide variety of conditioners and other hair treatment products are available for improving shine, volume, moisture content, manageability and/or other characteristics of hair. Some hair care appliances such as hair dryers, straighteners, curling irons and the like are even configured to deliver a hair treatment product, such as water, conditioner or other product to one's hair during use.

As an example, in one known configuration a hair dryer uses a pump to spray a fine mist of water droplets (or other hair treatment liquid) onto a subject's hair while the hair is being dried. The pumping system includes an internal motor that drives a reciprocating piston in a cylinder to alternately suck water from an attached container into an passage and force water and air from the passage out a nozzle positioned just beneath the air stream outlet of the hair dryer. The nozzle and air stream outlet are positioned and arranged so that a fine mist of droplets exits the nozzle in a generally conical spray pattern extending up and away from the bottom of the air stream outlet.

The spray pattern generated by this prior known hair dryer is not conducive to applying an even coating of hair treatment liquid to the subject's hair. In particular, the conical spray pattern does not lend itself to providing a relatively even distribution of the spray droplets from the bottom to the top of the stream of air exiting from the hair dryer. For example, where the hair dryer is waved side-to-side in the customary manner when blow drying, some hair would be very briefly wetted by the conical outer regions of the spray pattern, while other parts of the hair would be wetted substantially more by the central portion of the spray pattern. The ability to apply an even coating of the hair treatment liquid to the hair is desirable to reduce issues that may arise due to overcoating or undercoating the hair with the treatment liquid.

The piston pump used in this hair dryer has some additional characteristics that may be undesirable in some circumstances. For instance, it is difficult to achieve a relatively low spray rate with the piston pump. Thus, in order to avoid prematurely exhausting the supply of hair treatment liquid, the pump is likely operated in a few short bursts to limit the duty cycle of the pump and thereby limit the rate at which the hair treatment liquid supply is depleted. This may promote a tendency for users to apply the liquid unevenly and/or at suboptimal coverage rate.

Another disadvantage of the piston pump used in such a hair dryer the fluid delivery system relies on a dip tube to draw the liquid from the bottom of the supply reservoir. As the liquid is depleted and the liquid level in the supply reservoir moves down, it becomes more and more likely that changing the orientation of the hair dryer (e.g., so that it is on its side or upside down) will cause the end of the dip tube to terminate above the liquid level, thereby preventing operation of the pump. This undesirably restricts the user's freedom to manipulate the hair dryer as may be desired to dry all of the subject's hair while using the pump.

Also, the piston pump of this prior known hair dryer moves a piston in a reciprocating manner with a mechanical linkage drivingly connected to the pump motor. This tends to make the piston pump relatively noisy. Further, the energy used to move the piston back and forth translates into relatively high electrical power requirements. For example, it appears that an effort to power the piston pump with one or more batteries sized to fit inside the hair dryer would pose the problem of limited battery life.

Various conditioners and other liquid skin treatment products are available for application to a subject's skin. It may be desirable to apply such skin treatment products to a subject's skin at the same time that a facial or body hair care appliance (e.g., a shaver or trimmer) is being used on the skin. As in the case of hair treatment liquids, it is desirable to apply such liquids evenly to the subject's skin. Likewise, it may be desirable to use a hand held appliance that has no other purpose than to automatically (e.g., as opposed to manually pumping or spraying) apply liquid treatments to a subject's skin or hair.

### SUMMARY

One aspect of the invention is a hand held hair dryer including an air duct having an air inlet and an air outlet. A fan unit is operable to draw air into the duct at the air inlet and direct the air flow to the air outlet for exhaustion from the hair dryer. The hair dryer also includes a hair treatment liquid delivery system for delivering a hair treatment liquid from the hair dryer. The delivery system has a reservoir containing a supply of hair treatment liquid. A liquid transfer system is in fluid communication with the reservoir to transfer hair treatment liquid out of the reservoir. The liquid delivery system also has a rotatable drum having a surface in fluid communication with the liquid transfer system for receiving hair treatment liquid onto the surface of the drum. A drive system is operable to rotate the drum such that hair treatment liquid is thrown from the drum by centrifugal force of the rotating drum for delivering hair treatment liquid from the hair dryer in the form of a spray of droplets.

Another aspect of the invention is a liquid sprayer. The sprayer has a reservoir containing a supply of a liquid. The sprayer also includes a generally cylindrical drum having a longitudinal axis and being rotatable on said axis. The drum has an outer surface and a pair of flange members spaced longitudinally from each other and each extending radially outward from the drum outer surface. A drive system is operable to rotate the drum on said longitudinal axis. A liquid transfer system is operable to transfer liquid from the reservoir to the drum outer surface between the flange members whereby upon rotation of the drum on its longitudinal axis liquid is thrown from the outer surface of the drum by centrifugal force of the rotating drum for delivering liquid from the sprayer in the form of a spray of droplets.

Another embodiment of a liquid sprayer has a reservoir containing a supply of liquid and a rotatable drum having an outer surface in fluid communication with the reservoir for receiving liquid from the reservoir onto the outer surface of the drum. A liquid transfer system is in fluid communication with the reservoir to transfer liquid out of the reservoir and onto the drum outer surface. The liquid transfer system includes a first wicking member disposed in the reservoir free from contact with the drum outer surface and constructed to hold liquid in the reservoir and a second wicking member separate from the first wicking member and in fluid communication with the first wicking member to receive liquid from the first wicking member. The second wicking member is in contact with the drum outer surface for transferring liquid onto the drum outer surface. A drive system is operable to rotate the drum such that liquid is thrown from the drum outer surface by centrifugal force of the rotating drum for delivering liquid from the sprayer in the form of a spray of droplets.

A method of using a hand held appliance to dry and apply a hair treatment liquid to a subject's hair in accordance with one embodiment of the invention includes directing an air stream emitted from an air outlet of the appliance onto the subject's hair to dry the hair. Droplets of the hair treatment liquid are sprayed onto the subject's hair from a spray outlet of the appliance. The spraying is conducted so that the droplets produce a generally rectangular spray pattern on the subject's hair. The spray pattern has a length and a width, the length being longer than the width. The spraying is conducted so that the distribution density of droplets along the length of the spray pattern is substantially uniform. The spraying also includes moving the appliance so that the spray pattern translates over the subject's hair in a direction including a component parallel to the width of the spray pattern.

### BRIEF DESCRIPTION OF THE DRAWINGS

FIG. 1 is a perspective view of one embodiment of a personal care appliance in the form of a hair dryer capable of spraying a hair treatment liquid onto a subject's hair;

FIG. 2 is a perspective view of the hair dryer of FIG. 1 with portions removed to reveal internal construction;

FIG. 3 is an enlarged perspective view of a sprayer of the hair dryer of FIG. 1 for spraying hair treatment liquid from the hair dryer;

FIG. 4 is an exploded view of the sprayer of FIG. 3;

FIG. 5 is a top view thereof;

FIG. 6 is a cross-section taken in the plane including line 6-6 of FIG. 5;

FIG. 7 is a cross-section taken in the plane including line 7-7 of FIG. 5;

FIG. 8 is a perspective view of one embodiment of a drum for use with the sprayer of FIG. 3;

FIG. 9A is a schematic side elevation of one embodiment of a method of using the hair dryer of FIG. 1 to deliver a spray of hair treatment liquid to a subject's hair;

FIG. 9B is a schematic top plan view thereof;

FIGS. 10A-10B are schematic perspective views of the hair dryer of FIG. 1 illustrating a sequence in which a moveable shield of the sprayer is moved to adjust a spray rate of the sprayer, the shield being in a more open position in FIG. 10B than in FIG. 10A;

FIG. 11 is a perspective view of another embodiment of a personal care appliance, also in the form of a hair dryer capable of spraying a hair treatment liquid onto a subject's hair;

FIG. 12 is a perspective view of the hair dryer of FIG. 11 with portions removed to reveal internal construction;

FIG. 13 is a perspective view of a sprayer of the hair dryer of FIG. 11 with the sprayer detached from the hair dryer, and a cartridge for supplying hair treatment liquid to the sprayer;

FIG. 13A is a perspective view similar to FIG. 13 with the sprayer omitted;

FIG. 14 is an exploded perspective view of the cartridge of FIG. 13A;

FIG. 15 is a section taken in the plane including line 15-15 of FIG. 13;

FIG. 16 is a section taken in the plane including line 16-16 of FIG. 13;

FIGS. 17A-17C sequentially illustrate a manner in which the cartridge is removed from the hair dryer for refilling or replacement;

FIG. 18 is a perspective view of yet another embodiment of a personal care appliance, also in the form of a hair dryer capable of spraying a hair treatment liquid onto a subject's hair;

FIG. 19 is a perspective view of a sprayer of the hair dryer of FIG. 18 with the sprayer detached from the hair dryer, and a cartridge for supplying hair treatment liquid to the sprayer;

FIG. 20 is a perspective view similar to FIG. 19 with the sprayer omitted and a portion of the cartridge removed to show internal features;

FIG. 21 is an exploded view of the cartridge of FIG. 20;

FIG. 22 is a section taken in the plane including line 22-22 of FIG. 19;

FIG. 23 is a section taken in the plane including line 23-23 of FIG. 19; and

FIG. 24 is a perspective view of the cartridge of FIG. 20 with a portion of the cartridge removed to show internal features thereof.

Corresponding reference characters indicate corresponding parts throughout the drawings.

### DETAILED DESCRIPTION

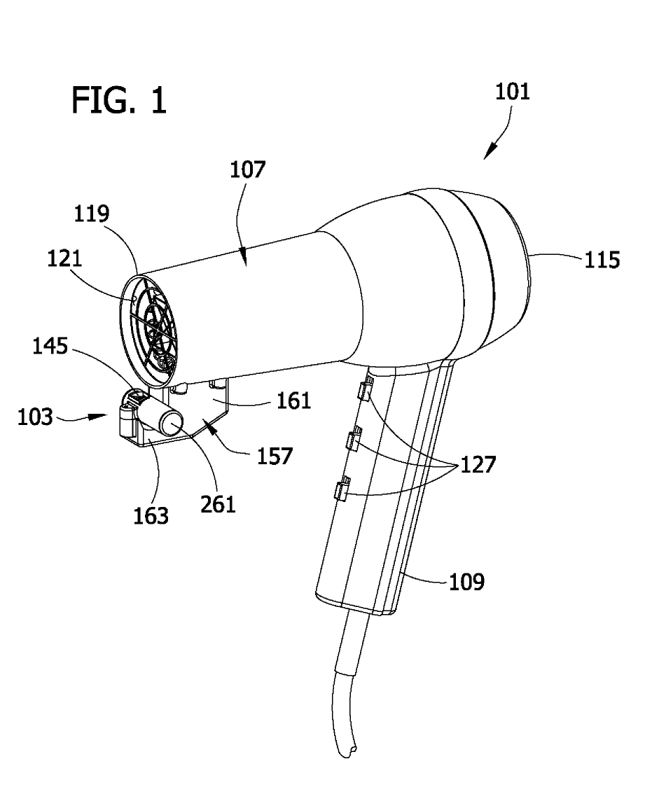

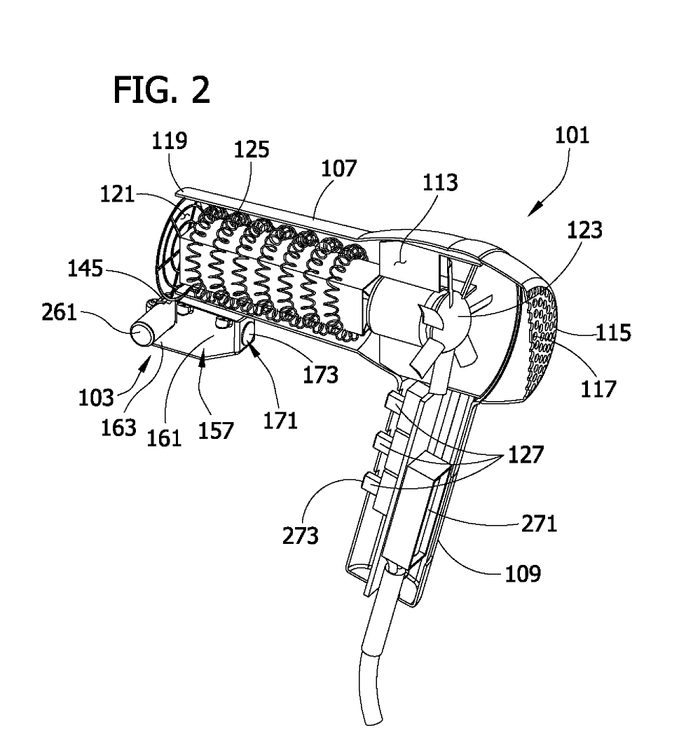

Referring now to the drawings and in particular to FIGS. 1 and 2, one embodiment of a hand held personal care appliance is illustrated in the form of a hair care appliance, and more particularly a hair dryer, generally designated 101, having a sprayer (broadly, a liquid delivery system), generally indicated at 103 for spraying hair treatment liquid 105 from the hair dryer for delivery to a subject's hair. It is understood, however, that the sprayer 103 as set forth herein may be carried by other hand held hair care appliances such as hair clippers and trimmers, combs, hair styling irons and the like, as well as to facial and/or body hair care appliances such as shavers and trimmers, without departing from the scope of the invention. In other embodiments, the sprayer may be used in hand-held spray delivery devices such as spray bottles, etc, that are used independent of a personal care appliance.

The hair dryer 101 comprises a barrel 107 and a handle 109 extending away from the barrel (e.g., roughly perpendicularly to a longitudinal axis of the barrel but not necessarily so). The barrel 107 has an interior air duct 113, an upstream or inlet end 115 that is open to define an air inlet 117 to the barrel at which air enters the air duct, and a downstream or outlet end 119 to define an air outlet 121 at which air exits the air duct, and hence the dryer. A fan unit 123 is disposed in the barrel 107 and is operable to draw air into the duct 113 at the air inlet 117 and direct air to flow therethrough to the air outlet 121. A suitable heater 125 is also disposed in the air duct 113 of the barrel 107 and is operable to heat air flowing through the air duct to deliver a stream of heated air exiting the outlet end 119 of the barrel. One or more controls 127 are provided on the handle 109 to allow selective activation and deactivation of the fan 123 and heater 125. For example, such controls 127 may allow selective activation and adjustment of the fan 123 speed independent of the heater 125 and/or allow a user to selectively adjust a power setting of the heater to control the amount of heat applied to a subject's hair, or to provide generally unheated air.

The hair dryer 101 described to this point is conventional, with the construction and operation thereof being known to those skilled in the art. It is understood that the hair dryer may be of any suitable construction to remain within the scope of this invention.

The term “liquid” as used in reference to the hair treatment liquid refers to any non-gaseous flowable substance. For example, suitable hair treatment liquids may include water, conditioner, a shine enhancer, a de-tangler, a hair styling liquid, a heat protectant, an ion solution, etc. The hair treatment liquid 105 is suitably selected or formulated to resist foaming and to avoid leaving a sticky residue when dry. In one particularly suitable embodiment, the hair treatment liquid 105 is selected or formulated to have a viscosity and density that approaches (or is equal to) that of water.

In a more particularly suitable embodiment, the hair treatment liquid 105 may comprise silicon, and more suitably a substantial fraction (e.g., about 90 weight percent or more) of a silicon-containing emollient, such as cyclopentasiloxane. Silicon-containing products, such as cyclopentasiloxane, can provide dual advantages when included in the hair treatment liquid in that they are considered beneficial to the hair and also act as a lubricant for the sprayer 103. The hair treatment liquid 105 suitably also includes a smaller fraction (e.g., about 10 weight percent or less) of another emollient, such as PPG-3 benzyl ether myristate, which is known for its ability to improve shine as well as moisturize the hair. Use of other compositions as the hair treatment liquid, however, is contemplated to be within the scope of this invention.

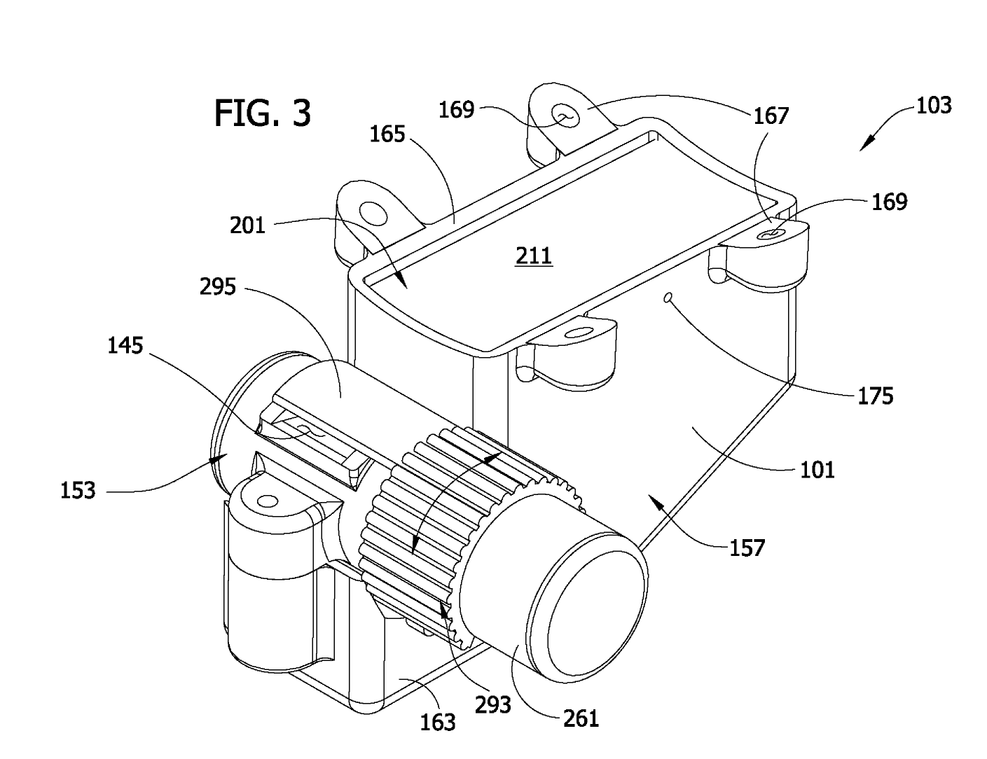

Referring now to FIGS. 1 and 3, the sprayer 103 is suitably mounted on the barrel 107 of the hair dryer 101 generally adjacent the downstream or outlet end 119 of the barrel. One or more components of the sprayer could also be made integrally with the barrel to secure the sprayer to the barrel. A spray outlet 145 of the sprayer 103, e.g., through which hair treatment liquid 105 exits the sprayer, is suitably disposed adjacent or at the air outlet 121 defined at the outlet end 119 of the barrel 107 for entraining the liquid exiting the sprayer in the air stream exiting the air outlet of the air duct 113. The sprayer outlet 145 is suitably under the air outlet 121. For example, in the illustrated embodiment of FIG. 1, the sprayer outlet 145 is disposed slightly downstream from the air outlet 121 of the hair dryer 101. It is understood, however, that the sprayer outlet 145 may be disposed upstream from the air outlet 121, e.g., along the air duct 113 formed by the barrel 107 of the hair dryer 101 with a window or other opening (not shown) formed in the barrel to permit the liquid 105 from the sprayer 103 to enter the barrel into the air duct upstream from the air outlet, without departing from the scope of this invention.

The sprayer 103 is suitably operable to deliver a spray of droplets of hair treatment liquid 105 from the sprayer. As best seen in FIGS. 3-7, the sprayer 103 generally comprises a rotatable drum 151 housed in a generally cylindrical drum housing 153, a motor 155 (broadly, a drive system) operable to rotatably drive the drum, a reservoir 157 containing a supply of the hair treatment liquid, and a liquid transfer system 159 in fluid communication with the reservoir and the drum to transfer hair treatment liquid 105 from the reservoir to the drum. An opening 145 formed in the drum housing 153 defines the spray outlet from which hair treatment liquid is sprayed from the sprayer.

The illustrated reservoir 157 is configured to have a generally rectangular main portion 161 and a tongue portion 163 extending outward (e.g., forward in the illustrated embodiment) from the main portion. The main portion 161 of the reservoir 157 is generally open at a mounting end 165 (i.e., an upper end or top in the illustrated embodiment) and has suitably flanged mounting members 167 including bores 169 therethrough to permit mounting of the reservoir (and hence the entire sprayer 103) on the underside of the hair dryer barrel 107 using suitable screw fasteners (not shown). The mounting end 165 of the reservoir main portion 161 is suitably contoured in accordance with the contour of the underside of the hair dryer barrel 107 to provide a relatively flush fit of the reservoir main portion against the barrel so that the barrel seals or at least generally closes the open mounting end of the reservoir main portion. In this manner, the reservoir 157 is closed off from the air duct 113 defined by the hair dryer barrel 107 to reduce the risk of evaporation or heat degradation of the hair treatment liquid 105 in the reservoir that may otherwise result from exposure to heated air within the barrel.

It is contemplated, however, that the reservoir 157 may instead be closed at its mounting end without departing from the scope of this invention. It also understood that the sprayer 103 may be mounted on the barrel other than by screw fasteners, such as by other suitable fasteners, welding, adhesive or other suitable fastening technique.

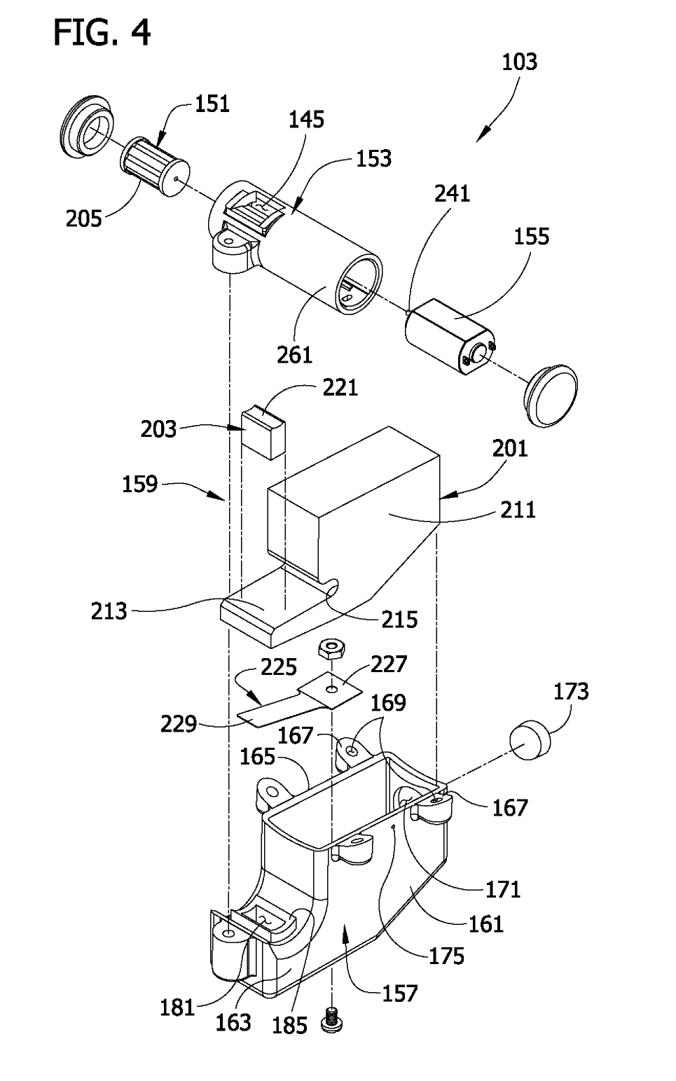

The reservoir 157 has a refill port 171 (FIGS. 2 and 4) through which hair treatment liquid 105 may be added to the reservoir to initially fill and/or periodically replenish the reservoir with hair treatment liquid. The refill port 171 is suitably closed by a cap 173 that is releasably secured to the reservoir 157 (e.g., by snapping the cap into the refill port). A vent opening 175 may also be provided in the reservoir 157 to reduce vacuum formation in the reservoir as liquid 105 is withdrawn therefrom. As an example, in the embodiment of FIG. 3 the vent opening is approximately 0.5 mm in diameter. The dimensions of the vent opening may vary, however, depending on venting requirements.

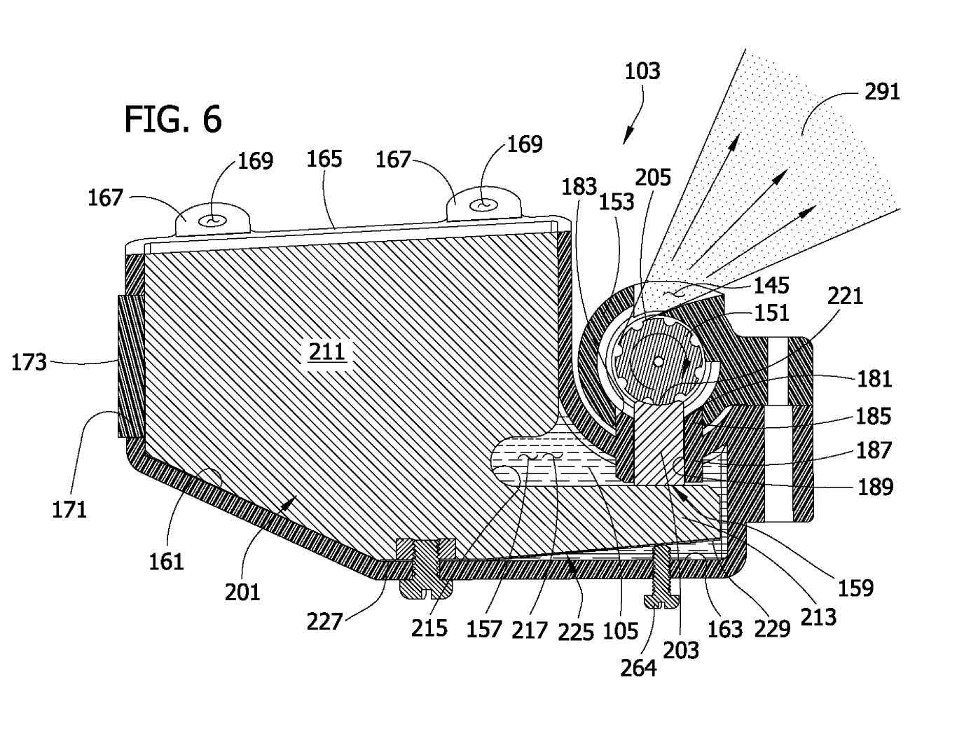

The tongue portion 163 of the reservoir is relatively flat and wide and extends outward (e.g., forward in the illustrated embodiment of FIG. 1) generally from the bottom of the main portion 161 of the reservoir 157. An outlet opening 181 (FIGS. 4 and 6) is formed in the tongue portion 163 of the reservoir 157, and more suitably in the top of the tongue portion, to provide fluid communication between the reservoir and the drum housing 153. In particular, the top of the tongue portion 163 of the reservoir 157, including the opening 181, is suitably contoured according to the contour of the generally cylindrical drum housing 153 to facilitate seating the drum housing on the reservoir.

In particular, as best seen in FIG. 6, the drum housing 153 has an inlet opening 183 formed therein to correspond (e.g., in shape and size) to the outlet opening 181 of the reservoir 157. A rim 185 extends up from the top of the tongue portion 163 of the reservoir 157 at the outlet opening 181 to seat the drum housing 153 on the tongue portion of the reservoir with the drum housing surrounding the upwardly extending rim at the inlet opening to the drum housing. In one particularly suitable embodiment, a guide member 187 is disposed in the tongue portion 163 of the reservoir 157, such as by being formed integrally therewith, to define the reservoir outlet opening 181, the upward extending rim 158, and a guide channel 189 (the purpose of which is described later herein) that extends down into the reservoir at the tongue portion. A gasket (not shown) or other sealing material may be used to create a liquid tight seal between the reservoir 157 and the drum housing 153.

In the illustrated embodiment, the reservoir 157 (i.e., the main portion 161 and tongue portion 163 together) has a total internal volume in the range of about 10 ml to about 32 ml, and more suitably in the range of about 20 ml to about 30 ml. It is understood, however, that the reservoir may be sized larger or smaller depending on a number of factors including the appliance with which it is used, the hair treatment liquid, spray rate, the desired time between needed refills, etc.

The liquid transfer system 159 suitably comprises a pair of wicking members 201, 203 disposed within the reservoir 157, at least one of which extends into contact with the outer surface 205 of the drum 151 in the drum housing 153 to wick hair treatment liquid 105 from the reservoir 157 to the drum outer surface. For reference purposes, a first or primary wicking member 201 is disposed in both the main portion 161 and tongue portion 163 of the reservoir 157 and is referred to further herein as the reservoir wick and a second or secondary wicking member 203 is disposed in the tongue portion of the reservoir, and more particularly in the guide channel 189 formed by the guide member 187 thereof, and is referred to further herein as the drum wick. It is contemplated, however, that more than two wicking members may be used, or that a single wicking member that defines both the reservoir wick and the drum wick may be used without departing from the scope of this invention.

The reservoir wick 201 illustrated in FIG. 4 is shaped generally in accordance with the reservoir 157 (i.e., the main portion 161 and tongue portion 163) and is contained entirely within the reservoir. In the illustrated embodiment, for example, the reservoir wick 201 comprises a main body 211 sized and shaped to substantially fill the main portion 161 of the reservoir 157 so that capillary action of the main body reduces, and possibly completely offsets, head pressure at the tongue portion 163 of the reservoir when the reservoir is filled to a level that is higher than the level of the tongue portion. This reduces concerns that the head pressure might affect the spray rate and/or cause leakage of liquid 105 from the sprayer 103. The reservoir wick 201 also suitably absorbs free liquid 105 in the reservoir 157, thereby alleviating concerns about leakage of the liquid from the refill port (e.g., when the cap 173 is removed to open the refill port) and from the vent 175.

A cantilevered portion 213 of the reservoir wick 201 is integrally formed with and extends outward (e.g., forward in the illustrated embodiment) from the lower part of the main body 211 of the reservoir wick into the tongue portion 163 of the reservoir 157. As illustrated in FIGS. 4 and 6, a notch 215 suitably extends into the main body 211 of the reservoir wick 201 just above the cantilevered portion 213 to facilitate flexing of the cantilevered portion relative to the main body. The notch 215 is suitably at about the same level as or slightly below the level of the tongue portion 163 of the reservoir 157. The notch 215 extends sufficiently into the main portion 211 of the reservoir 157 to provide a pocket 217 in the reservoir that is devoid of the reservoir wick 201. There is also room for the cantilevered portion 213 of the wick 201 to flex up and down in the tongue portion 163 of the reservoir 157.

The reservoir wick 201 otherwise suitably occupies a substantial portion of the internal volume of the reservoir 157. For example, the reservoir wick 201 suitably occupies at least about 80 percent of the total internal volume of the reservoir 157, more suitably at least about 90 percent of the internal volume of the reservoir, and still more suitably at least about 95 percent of the internal volume of the reservoir. Further, the reservoir wick 201 suitably occupies substantially all of the portion of the internal volume of the reservoir 157 that is above the reservoir tongue 163.

With particular reference to FIGS. 4 and 6, the drum wick 203 is generally rectangular, block-shaped and extends within the channel 189 formed by the reservoir guide member 187 into contact with the reservoir wick 201, such as by seating on the cantilevered portion 213 thereof, in the tongue portion 163 of the reservoir 157. The drum wick 203 extends from the reservoir wick 201, outward through the guide member 187 into direct contact with the outer surface 205 of the drum 151 within the drum housing 153. The end 221 of the drum wick 203 that contacts the drum outer surface 205 is suitably contoured according generally to the contour of the drum outer surface. For instance, in the illustrated embodiment the drum contact end 221 of the drum wick 203 may be generally concave according to a radius that is about the same as the radius of curvature of the outer surface 205 of the drum 151.

The drum wick 203 is suitably slidable relative to the guide member 187 of the reservoir to permit inward and outward movement of the drum wick relative to the reservoir 157. More suitably, the drum wick 203 is biased outward against the outer surface 205 of the drum 151 to maintain a positive contact with the. One advantage of biasing the drum wick 203 to engage the outer surface 205 of the drum 151 is that it alleviates the need to maintain tight tolerances on the dimensions of the drum wick 203 and reservoir wick 201. It also helps maintain a desired contact pressure between the drum wick 203 and the drum 151. To facilitate movement of the drum wick 203, the cantilevered portion 213 of the reservoir wick 201 is suitably biased against the drum wick to maintain contact with the drum wick and urge the drum wick against the drum outer surface 205. However, it is contemplated that the contact pressure between the drum wick 203 and the drum 151 is suitably relatively light. For example, in one embodiment, the contact pressure is substantially maintained in the range of about 0.085 grams per square millimeter to about −0.4 grams per square millimeter.

As illustrated in FIGS. 4 and 6, this contact pressure is suitably maintained by a biasing member 225, and more suitably a leaf spring disposed in the bottom of the reservoir 157. The leaf spring 225 is positioned and arranged so that it urges the cantilevered portion 213 of the reservoir wick 201 up into contact with the drum wick 203 and consequently urges the drum wick up into contact with the drum 151. For example, the leaf spring 225 suitably has one end 227 attached to the bottom of the reservoir 157 under the main body 211 of the reservoir wick 201. The leaf spring 225 extends along the bottom of the reservoir 157 to an opposite free end 229 disposed under the cantilevered portion 213 of the reservoir wick 201. The free end 229 of the leaf spring 225 is spaced away from the bottom of the reservoir 157 when the spring is in its relaxed state.

The leaf spring 225 is resiliently deformable to a configuration in which its free end 229 is closer to the bottom of the reservoir 157 than it is in the relaxed state of the spring. The drum wick 203 and the cantilevered portion 213 of the reservoir wick 201 are suitably dimensioned so that they resiliently deform the leaf spring 225 by pressing its free end 229 toward the bottom of the reservoir 157 when the drum wick is in contact with the drum 151. Consequently, the leaf spring 225 presses back against the cantilevered portion 231 of the reservoir wick 201 and the drum wick 203. Further, by selecting the leaf spring 225 so that it has an appropriate spring constant, the contact pressure between the drum wick 203 and the drum 151 can be maintained in a desired range.

Although the illustrated embodiment uses a separate leaf spring 225 to bias the wicking members toward the drum 151, a separate leaf spring (or other biasing member) is not required. For example, a leaf spring (not shown) similar to the one described above may be embedded in the wicking material of the reservoir wick 201 to resiliently bias the cantilevered portion 213 of the wick to flex upwardly and to urge the drum wick 203 up against the drum 151. Likewise, natural resiliency of the cantilevered portion 213 of the reservoir wick 201 may be sufficient to maintain contact of the drum wick 203 with the drum 151 in a suitable pressure range without departing from the scope of the invention. Further, it is within the scope of the invention to achieve a desired contact pressure by configuring the sprayer 103 so that the drum wick 203 and cantilevered portion 213 of the reservoir wick 201 are squeezed between the drum 151 and the reservoir containment structure. It may be desirable in some embodiments to provide a mechanism (e.g., a contact pressure adjustment screw 264, as illustrated in FIG. 6) to selectively increase the contact pressure as the drum wick 203 is worn down by the drum 151.

Various materials may be used for the drum wick 203 and reservoir wick 201. In general, materials that are capable of wicking the liquid are suitable for use as the wicking members 201, 203 without departing from the scope of the invention. In one embodiment, for example, the drum wick 203 and reservoir wick 201 are made of a fibrous polyester material. Examples of suitable wicking materials are those commercially available from Filtrona Richmond, Inc., which has a U.S. office in Colonial Heights, Va. under the tradename Filtrona Fibertec®. Suitable wicks are available from Spectrum Brands, Inc. of Madison, Wis. as part numbers 06-650-003 and 06-650-004. It is understood, however, that other wicking materials, such as cotton or other suitable materials, may be used without departing from the scope of the invention.

In one embodiment of the invention, wicking material is made by forming a web of extruded polyester fibers oriented so that a substantial fraction of the fibers are in roughly parallel orientation to one another to form a fibrous matrix. The drum wick 203 and reservoir wick 201 are suitably produced from one or more such webs so that the substantial fraction of roughly parallel polyester fibers are perpendicular to the general direction of liquid flow through the wicking members.

The drum wick 203 in one embodiment suitably has a higher average density than the reservoir wick 201. For example the drum wick 203 may suitably have an average density in the range of about 0.19 g/cc to about 0.25 g/cc while the reservoir wick has an average density in the range of about 0.095 g/cc to about 0.19 g/cc. A lower density reservoir wick 201 provides more internal void space for containing a relatively larger volume of hair treatment liquid 105 therein. The higher density drum wick 203 provides a stronger capillary action than the reservoir wick 201 to facilitate the drum wick drawing liquid 105 from the reservoir wick for delivery to the drum outer surface 205.

The drum 151 is rotatably mounted on a suitable drive shaft 241 within the drum housing 153 so that the drum outer surface 205 is accessible to the drum wick 203 via the inlet opening 183 of the drum housing 153. The drive shaft 241 is operatively driven by the motor 155 (which may be any of various suitable electrical motors) with the drive shaft (and hence the rotation axis of the drum 151) generally perpendicular to the desired direction in which the spray of liquid 105 is to be directed, and more suitably to the direction of the flow through the air duct 113 of the hair dryer barrel 107. As an example, in one embodiment the drum 151 has a length of about 12 mm and an outer diameter of about 7 mm. It is understood, however that the drum size may vary without departing from the scope of this invention. Various materials may be used to make the drum 151. For example, in one embodiment the drum is suitably made from a relatively durable and inert polymer (e.g., polypropylene or Nylon). Polypropylene, and to a somewhat lesser extent Nylon, are also advantageous materials for use in making the drum 151 because their relatively high natural lubricity reduces resistance to rotation of the drum and thereby decreases the load on the motor.

FIG. 8 illustrates one embodiment of a suitable drum configuration in which the drum outer surface 205 has a plurality of longitudinally extending (relative to the longitudinal or rotational axis of the drum 151) grooves 251 formed therein and equispaced circumferentially from one another about the drum outer surface. For example, eight such grooves 251 are formed in the outer surface 205 of the drum 151 of FIG. 8. Each of the grooves 251 is generally semi-cylindrical in cross-section and has a radius of about 0.5 mm. Similarly, one or more longitudinally extending ridges (not shown) may be used instead of, or in combination, with the grooves 251 on the outer drum surface 205. Increasing the number of grooves 251 or ridges generally corresponds to an increase in the spray rate. Thus, the number of grooves 251 and/or ridges can be adjusted to adjust the spray rate as desired for a particular application. It is understood, for example, that any number of grooves may be formed in the drum outer surface, including a single groove or more than eight grooves, without departing from the scope of this invention.

The drum can be knurled or otherwise textured as an alternative or in addition to the foregoing way to adjust spray rate produced by the drum. In other embodiments, for example, the spray rate can be increased by providing bumps and/or circular depressions in the outer surface of the drum.

The drum 151 also has a pair of flange members 255 spaced longitudinally from each other, e.g., at opposite ends of the drum, and extending radially outward relative to the drum outer surface 205. As an example, one suitable way make a drum 151 having the illustrated flange members 255 is to make the flange members separate from the drum and integral with a post (not shown) connected to the flange centrally on a face of the flange. The posts of the flanges 255 are then suitably inserted into a hollow cylindrical cavity (not shown) in the drum 151. The ends of the posts are suitably designed so that the ends of the posts can be joined to one another (e.g., by a snap connection) in the hollow cavity in the drum 151.

In a particularly suitable embodiment, the grooves 251 and/or ridges in the drum outer surface extend all the way across the outer surface 205 of the drum 151 from one flange member 255 to the other. The flanges 255 suitably have a width of about 1 mm and are about 1 mm larger in diameter than the diameter of the drum outer surface 205. The drum 151 and the drum wick 203 are sized relative to each other such that the drum wick contacts the drum between the flange members 255 so that liquid 105 is delivered by the liquid transfer system 159 to the drum between the flange members. For example, in one embodiment the drum wick 203 is suitably sized and shaped to engage the drum outer surface 205 over a contact area that extends a longitudinal distance that is at least about 75 percent of the longitudinal distance between the flange members 255. Without being bound by any particular theories, the flange members are believed to play a desirable role in channeling the liquid so that the spray pattern is confined to a relatively narrow band along the longitudinal axis of the drum.

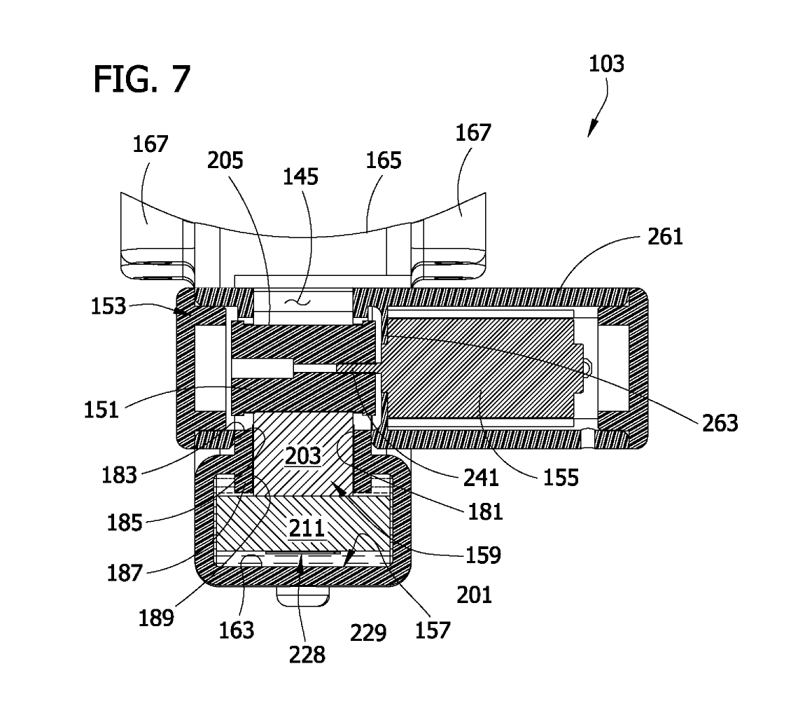

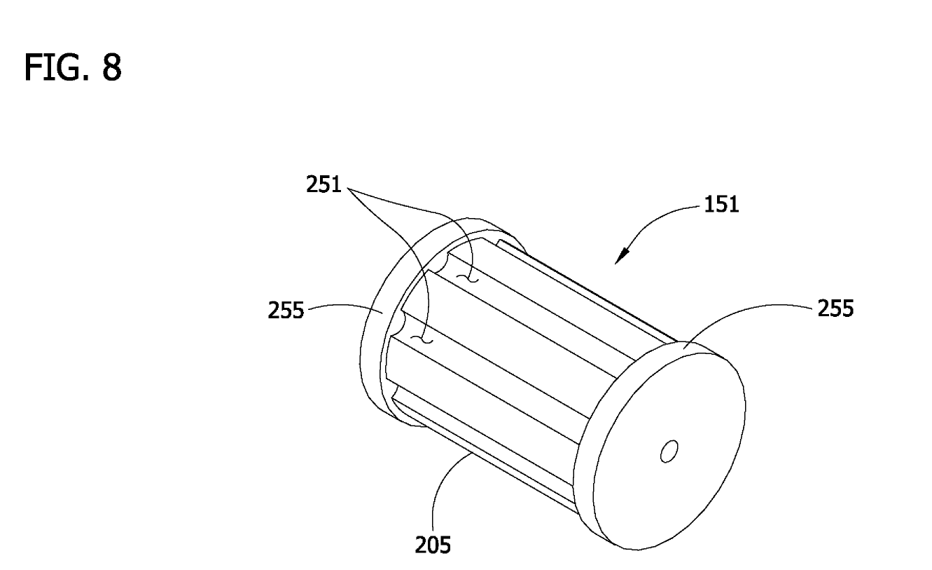

The drive motor 155 for the drum 151 is suitably disposed in a motor housing 261. For example, as illustrated in FIGS. 3 and 4 the motor housing 261 is a substantially cylindrical extension of the drum housing 153, and is more suitably formed integrally with the drum housing. A wall 263 (FIG. 7) suitably separates the inside of the motor housing 261 from the inside of the drum housing 153 to shield the motor 155 from the liquid 105 in the drum housing. The drive shaft 241 of the motor 155 extends through an opening 265 in the wall 263 to drivingly connect to the drum 151. An O-ring (not shown) or other sealing member suitably seals the inside of the motor housing 261 from the inside of the drum housing 153.

There are various options for activating the motor 155 within the scope of the invention. For instance, in one suitable embodiment the motor 155 may be selectively activated independent of the hair dryer fan 123 and/or heater 125 to permit use of the sprayer 130 even when a stream of air is not being used to dry the subject's hair. Alternatively, the motor 155 may be electrically connected to the fan 123 so that it operates conjointly with the hair dryer fan, i.e., only when a stream of air is exhausted from the dryer. It is contemplated that the motor 155 may be powered by the same power source as the fan 123 and heater 125, or by its own separate power source, without departing from the scope of the invention. For example, the illustrated motor of FIG. 2 is suitably powered by a separate power source (e.g., a 1.5 V battery in the handle 109 of the hair dryer 101). In any case, the motor 155 is suitably operable in one embodiment to rotate the drum 151 at a rate ranging from about 12,000 rpm to about 16,000 rpm. However, this rate may be greater or less than the above range, depending on for example on the desired spray rate, without departing from the scope of this invention.

In one embodiment, the sprayer 103 is suitably operable continuously, for example, to continually deliver hair treatment liquid 105 until the sprayer is turned off. In other embodiments, the sprayer 103 may be controllable, such as by a suitable button 273 (e.g., a push button) included in the set of controls 127 on the handle 109 or elsewhere on the hair dryer, to provide short bursts of liquid delivery. It is understood that the arrangement of the sprayer control button relative to the other controls on the handle may vary from the illustrated embodiment without departing from the scope of the invention.

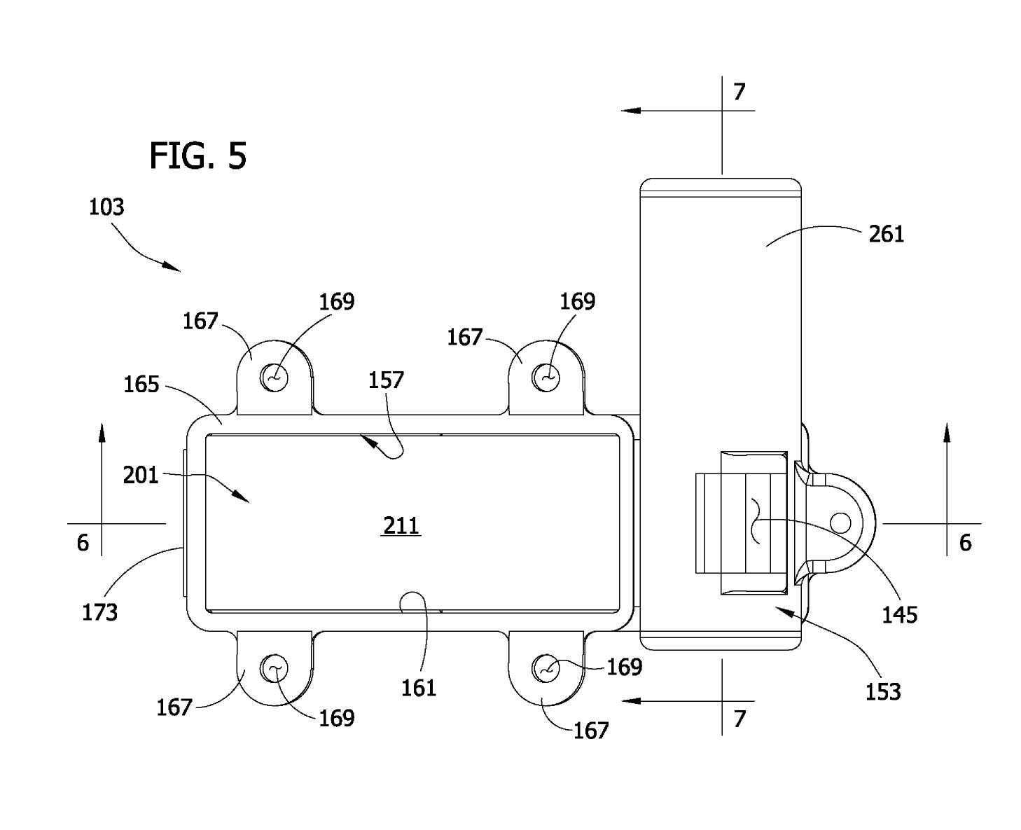

With reference to FIG. 5, the sprayer outlet 145 formed in the drum housing 153 is suitably a generally rectangular opening sized no longer than the length of the drum 151. For example, the sprayer outlet 145 according to one example my be a rectangular opening having a width in the range of about 2 mm to about 3 mm and a length in the range of 6 mm to about 9 mm. The rectangular opening 145 is suitably oriented so its length is generally parallel to the rotational axis of the drum.

In operation of the sprayer 103 the motor 155 drives the drum 151 in rotation (e.g., clockwise in the illustrated embodiment of FIG. 6). When rotated in this direction, the surface 205 of the drum 151 that is adjacent the sprayer outlet 145 is moving from one edge 281 of the opening 145 (the “back” edge) to the opposite edge 283 of the opening (the “front” edge). The drum housing 153 is suitably configured at the sprayer outlet 145 to define a deflector rib 285 at the front edge 283 of the opening. The deflector rib 285 extends radially inward of the back edge 281 of the opening 145, thereby resulting in the front edge 283 of the opening being closer to the drum 151 than the back edge. The deflector rib 285 has an upper surface 287 extending obliquely from the front edge 283 of the opening 145 to the exterior surface 205 of the drum housing 153 and generally aligned with a line extending tangentially to the surface of the drum 205. The upper surface 287 of the deflector rib 285 thereby constitutes a ramp leading from the front edge 283 of the spray outlet 145 to the exterior surface of the drum housing 153. The ramped nature of the upper surface 287 is advantageous because it generally returns excess liquid that may accumulate on the drum housing 153 at the front edge 283 of the spray outlet 145 to the inside of the drum housing reducing the amount of such liquid that dribbles down the outside of the drum housing.

Upon rotation of the drum 151, hair treatment liquid 105 from the reservoir 157 is transferred by the liquid transfer system 159, i.e., the reservoir wick 201 and then the drum wick 203, onto the outer surface 205 of the drum. The rotational speed of the drum 151 is such that hair treatment liquid 105 (e.g., the liquid captured in the grooves 251) is thrown from the drum due to centrifugal force. A volume of liquid 105 is thus thrown out through the sprayer outlet 145 in the form of a mist or spray of droplets 291 of the hair treatment liquid. A remaining volume of liquid 105 thrown from the drum outer surface 205 contacts the drum housing 153 and flows back along the drum housing to the drum wick 203. For example, referring to FIG. 6, the spray droplets 291 have initial trajectories that are roughly tangent to the drum 151 at the point at which they detach from the drum. Some droplets 291 thus detach from the drum at a location that is closer to the drum wick 203 than others. Droplets 291 that detach from the drum too soon will collide with the drum housing 153 adjacent the back edge 281 of the spray outlet 145. Likewise, droplets 291 that detach from the drum too late will collide with the deflector rib 285. Because the droplets 291 detach from the drum 151 at various locations relative to the edges 281, 283 of the outlet 145, the droplets fan out vertically (when the sprayer is oriented as illustrated in FIG. 6) after they exit the outlet.

The sprayer outlet 145 is suitably positioned relative to the air duct 113 of the hair dryer 101 such that hair treatment liquid 105 exiting the drum housing 153 can be entrained in the air flow of the hair dryer 101 when the fan 123 and sprayer 103 are operated concurrently. As illustrated in FIGS. 1 and 2, for example, the sprayer outlet 145 is suitably located beneath the barrel 107 of the hair dryer 101 adjacent and slightly forward of the air outlet 121. Further, the sprayer 103 is positioned and arranged so that upon rotation of the drum 151 by the motor 155, the spray of droplets 291 of hair treatment liquid 105 are thrown outward through the spray outlet 145 opening generally at an angle relative to the air flow direction up and forward into the air stream. For example, in one embodiment the droplets 291 of hair treatment liquid are thrown outward through the spray outlet 145 at an angle from about 5 degrees to about 40 degrees relative to the direction of air flow exiting the hair dryer.

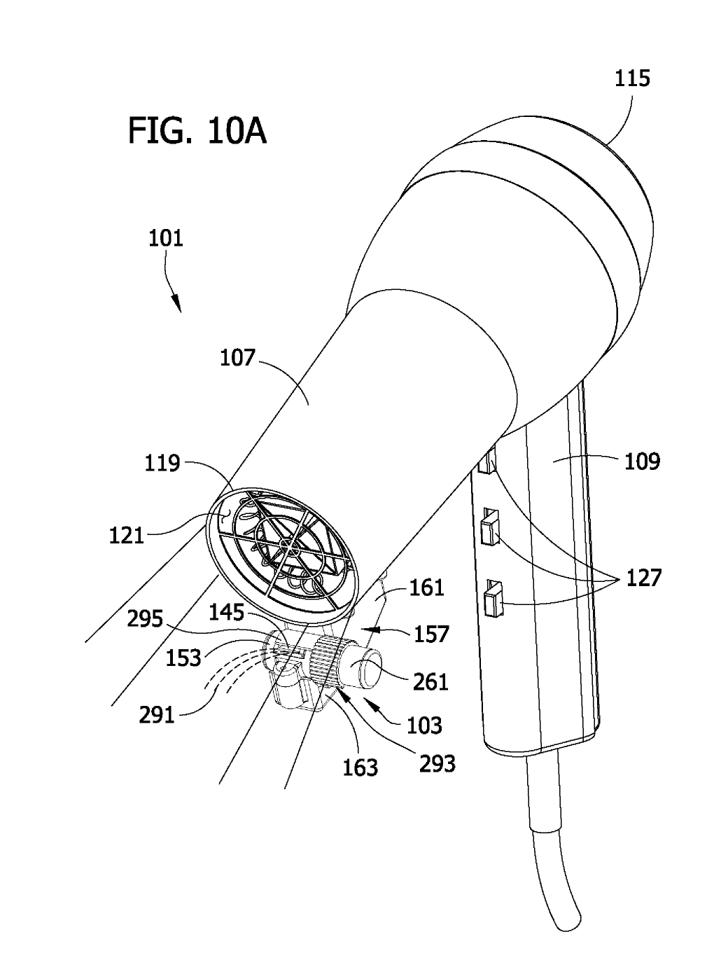

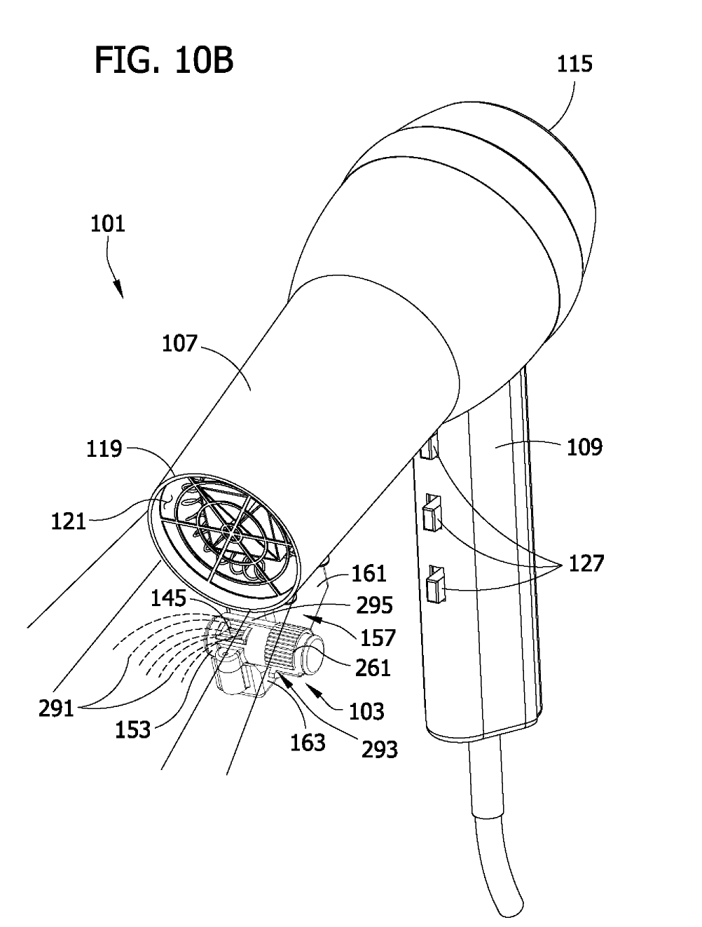

In accordance with one suitable embodiment, the spray rate at which hair treatment liquid 105 is delivered from the sprayer 103 is suitably at least about 0.00025 ml/sec, more suitably at least about 0.0005 ml/sec, and still more suitably about 0.001 ml/sec. The spray rate is optionally selectively variable by the user. For example, the motor 155 may be wired to a speed control circuit that enables a user to use the controls 127 on the handle 109 to speed up the rotation rate of the motor to increase the spray rate and/or decrease the rotation rate of the motor to decrease the spray rate. Another option that may be used alternatively or in addition to the variable motor speed feature is to provide the sprayer 103 with a shield that may be selectively moved to control the size of the sprayer outlet. As illustrated in FIGS. 3 and 10A-10B, for example, in one embodiment the sprayer 103 optionally includes a substantially cylindrical clip 293 rotatably mounted on the motor housing 261. A shield 295 extends from the clip 293 and is rotatable therewith. The shield 295 is shaped to conform to the cylindrical exterior of the drum housing 153 and is rotatable on the drum housing. By rotating the clip 293, the shield 295 can be selectively rotated (in the direction of the arrow on FIG. 3) to cover or uncover some or all of the sprayer outlet 145 to adjust the spray rate.

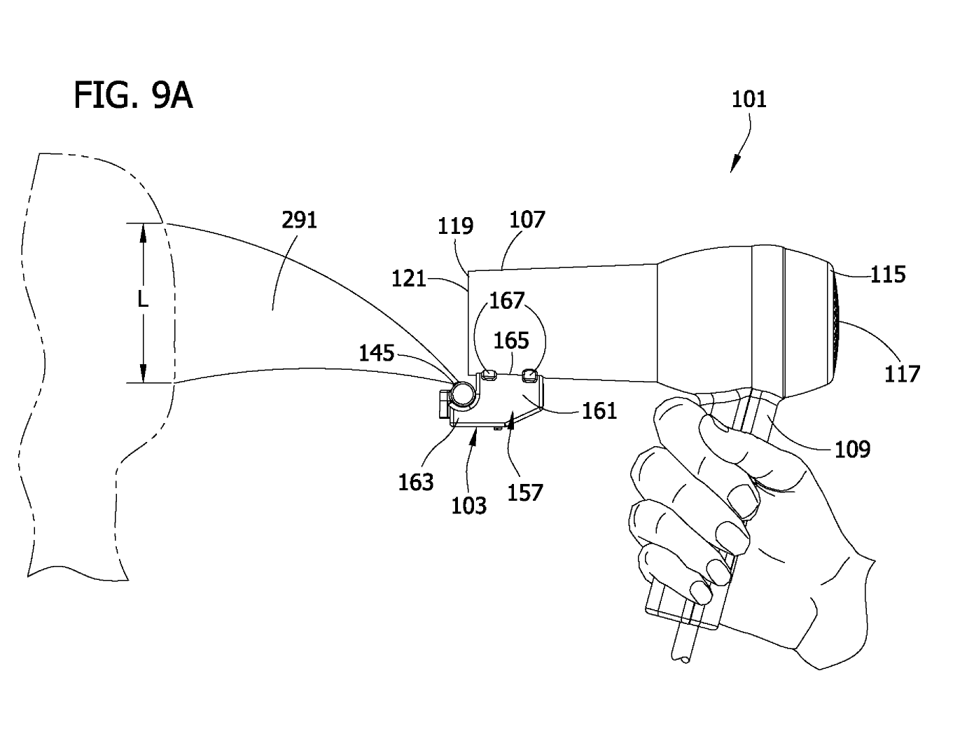

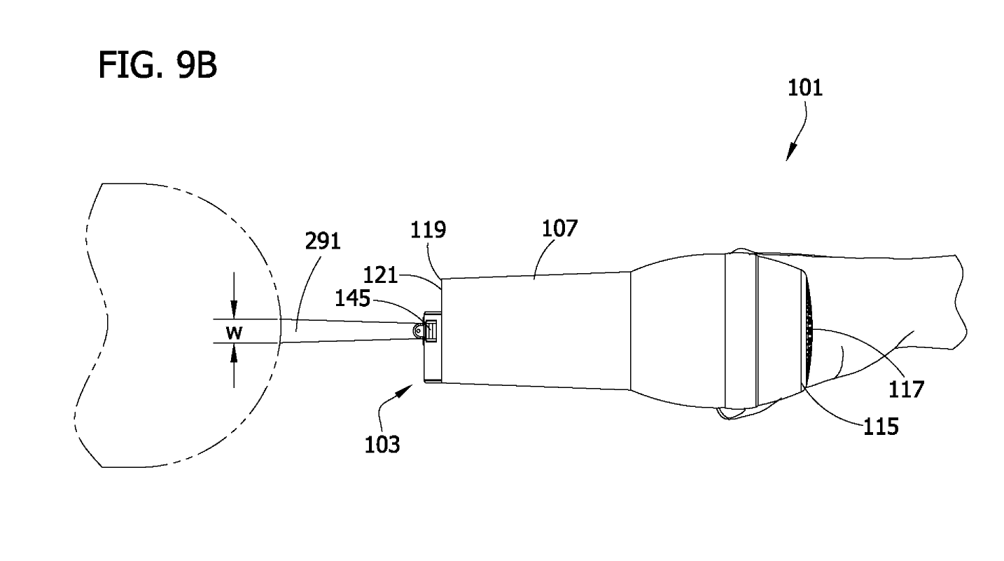

The spray pattern generated by the sprayer 103 is particularly advantageous in that it facilitates applying the hair treatment liquid 105 evenly to the hair or to a selected part of the hair. The droplets 291 suitably have substantially zero velocity in a direction parallel to the rotational axis of the drum 151. Consequently, as illustrated in FIG. 9B, the droplet 291 spray pattern does not fan out significantly in a direction parallel to the rotational axis of the drum 151. However, the trajectories of the droplets 291 suitably vary significantly in a direction perpendicular to the rotational axis of the drum 151. Consequently, the spray pattern fans out a significant amount in a direction perpendicular to the rotational axis of the drum, as indicated in FIG. 9A. In particular, the spray rate and pattern sufficiently distributes droplets relatively equally in an upper, middle, and lower portion of the air stream. The result, as illustrated in FIGS. 9A-9B, is a relatively narrow, generally rectangular spray pattern onto the hair. The spray pattern (measured while the fan 123 is off) suitably has a relatively narrow width W (e.g., about 10 mm in the direction extending parallel to the rotational axis of the drum) downstream of the spray outlet 145. At the same time, the length L of the spray pattern is much greater (e.g., about 10 times greater) than the width W. For example, in one embodiment, the spray pattern has a relatively narrow width W and a length L of about 85 mm. Furthermore, the distribution density of droplets 291 is fairly uniform along at least a substantial portion of the length of the rectangular spray pattern. It is understood that operation of the fan 123 affects the trajectories of droplets 291 and thereby also affects the spray pattern. However, the spray pattern suitably maintains a relatively high ratio of length L to width W while the fan 123 is operated to dry the subject's hair.

The spray pattern makes it easier to achieve relatively even coverage of the hair treatment liquid 105 on the subject's hair. For example, the hair dryer 101 may be held in the orientation depicted in the drawings and moved horizontally while spraying the hair treatment liquid 105 from the sprayer 103. In this orientation, the length L of the rectangular spray pattern is generally vertical. As the hair dryer 101 moves horizontally, the horizontal translation of the rectangular spray pattern of the sprayer 103 results in application of the hair treatment liquid 105 substantially evenly to a rectangular swath of hair. In contrast to prior art sprayers that have been used with hair dryers, which have generally conical spray patterns, about the same amount of the hair treatment liquid is applied to the upper and lower portions of the swath as is applied to the middle portion of the swath.

The sprayer 103 is operable to generate the spray in substantially any orientation. The optional vent 175 in the reservoir 157 is resistant to leakage because the reservoir wick 201 absorbs free liquid 105 in the reservoir. Thus, there is no significant leaking from the vent opening 175 regardless of orientation. The inner surface of the drum housing 153 and the upper surface of the rim 185 of the reservoir 157 are effective to return any liquid 105 that accumulates in the drum housing over a range of orientations. For example, the hair dryer 101 may be rotated up to about 45 degrees in any direction relative to the orientation in the drawings and operated for an indefinite period of time without leaking liquid.

The sprayer 103 has been found to be energy efficient. Substantially no energy is required to transport the liquid 105 from the reservoir 157 to the drum 151. Similarly, the load on the motor 155 is relatively light because of the lubricating action of the hair treatment liquid 105, the natural lubricity of the drum 151, and the relatively light contact pressure between the drum and the drum wick 203. Accordingly, the motor 155 is able to power the sprayer 103 to operate as described above while only drawing a relatively small current from a single 1.5 V AA size battery 271. For example the motor 155 is suitably operable to power the sprayer 103 while drawing less than about 250 mA from a single 1.5 V AA size battery 271, and more suitably while only drawing about 200 mA from the battery.

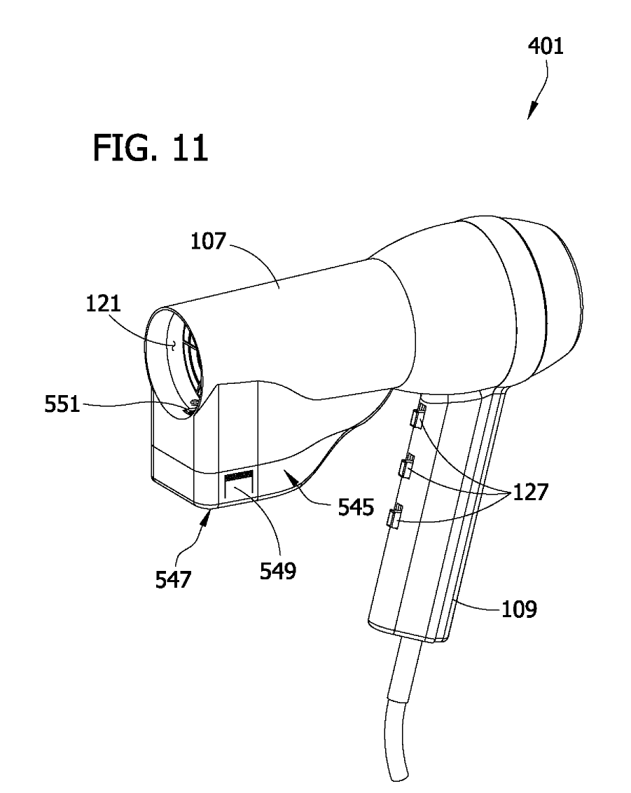

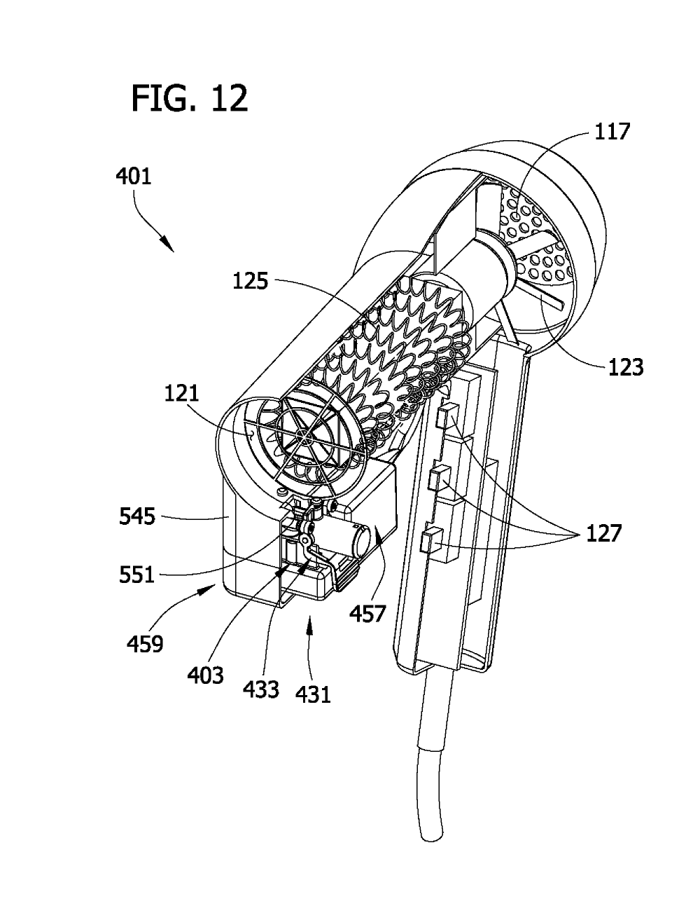

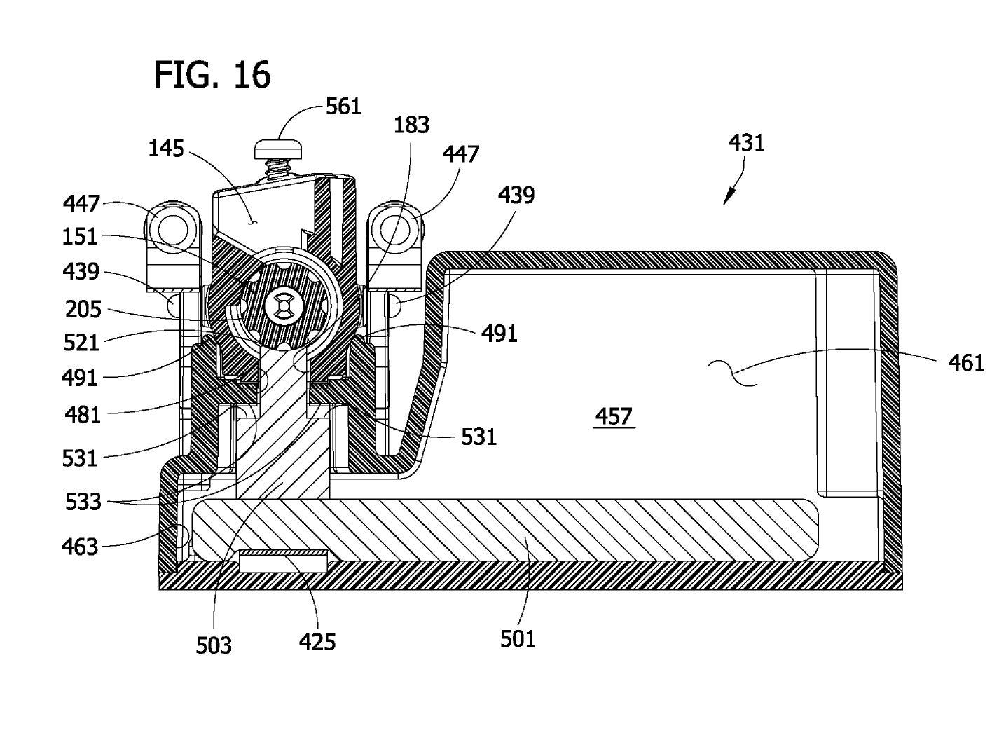

With reference now to FIGS. 11-17C, in another embodiment of a personal care appliance capable of delivering a spray of liquid the appliance is again illustrated in the form of a hair dryer, generally designated 401. Except as noted, this hair dryer 401 is constructed and operated in substantially the same way as the hair dryer 101 described above. In particular, for this embodiment the reservoir 457 is defined by a cartridge 431 that is releasably attached to the hair dryer 401 to permit refilling or replacement while the drum 151 remains secured to the hair dryer.

For example, the illustrated cartridge 431 comprises the reservoir 457 and the liquid transfer system 459 (e.g., a reservoir wick 501, and a drum wick 503). The drum 151, drum housing 153 and motor housing 261, and the motor 155 are not part of the cartridge 431 and suitably remain secured to the hair dryer 401 (e.g., via screws 561 or any other suitable means) during cartridge replacement. Such a cartridge based reservoir system facilitates replacement of a reservoir that is depleted of hair treatment liquid with another reservoir that is substantially filled with hair treatment liquid. The cartridge system also facilitates a changeover from one hair treatment liquid to a different hair treatment liquid, if that is desired. Very little to no liquid product is retained on the drum 151 between use. Thus, as soon as the sprayer 403 begins operation with a new cartridge containing a different hair treatment liquid than was in the immediately preceding cartridge, the sprayer will begin spraying droplets that are substantially entirely made of the new treatment right away.

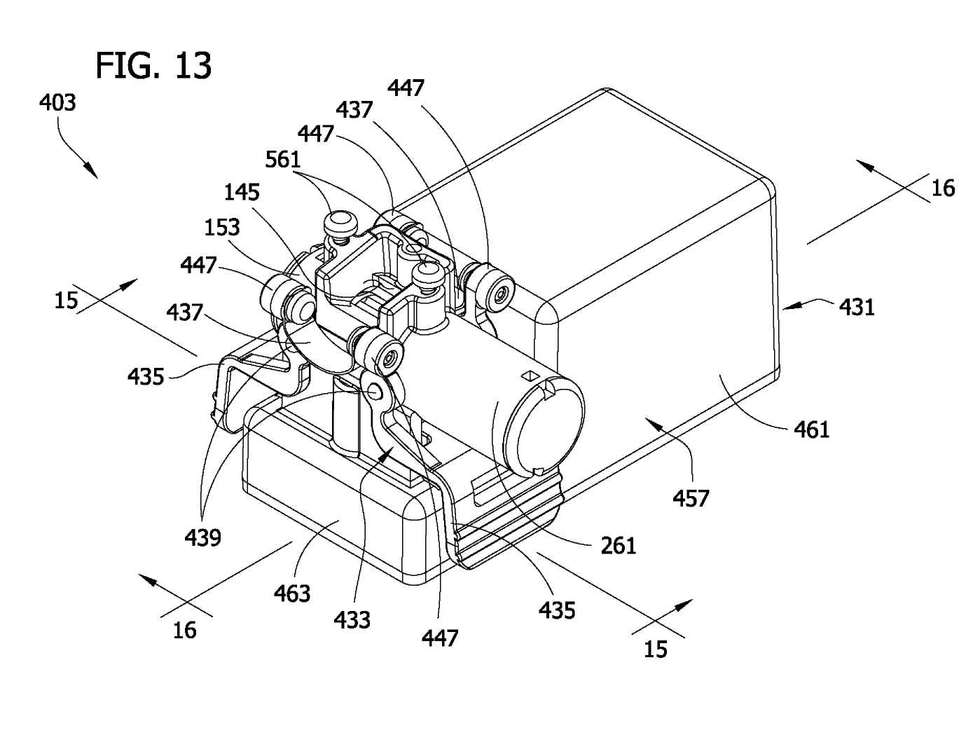

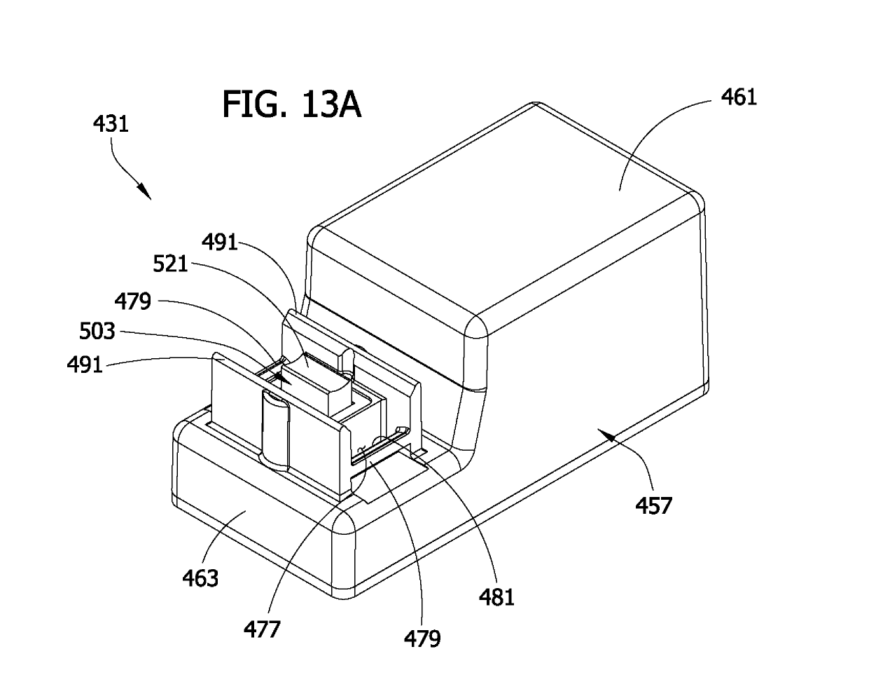

A latch system 433 for securing the cartridge 431 to the hair dryer 401 is suitably supported by the drum and motor housing 153, 261. In the embodiment illustrated in the drawings, for example, the latch system 433 comprises a pair of opposed jaws 435 pivotally mounted on the drum and motor housing 153, 261 at pivot connections 439. The lower portions of the jaws 435 are suitably configured to generally define a space sized and shaped to receive the tongue-defining portion 463 of the reservoir containment structure between the jaws. The jaws 435 are also biased (e.g., by biasing members 437 acting on upper ends of the jaws above the pivot connections 439) so their lower portions are urged to pivot generally away from one another. As illustrated in FIG. 13, for example, each jaw 435 suitably has a pair of arms 447 extending above the pivot connection 439 on opposite sides of the drum and motor housing 153, 261. A pair of leaf springs 437 on opposite sides of the drum and motor housing 153, 261 are stretched between the arms 447 of the jaws 435, thereby connecting the upper ends of the jaws to one another and biasing the upper ends of the jaws to move toward one another.

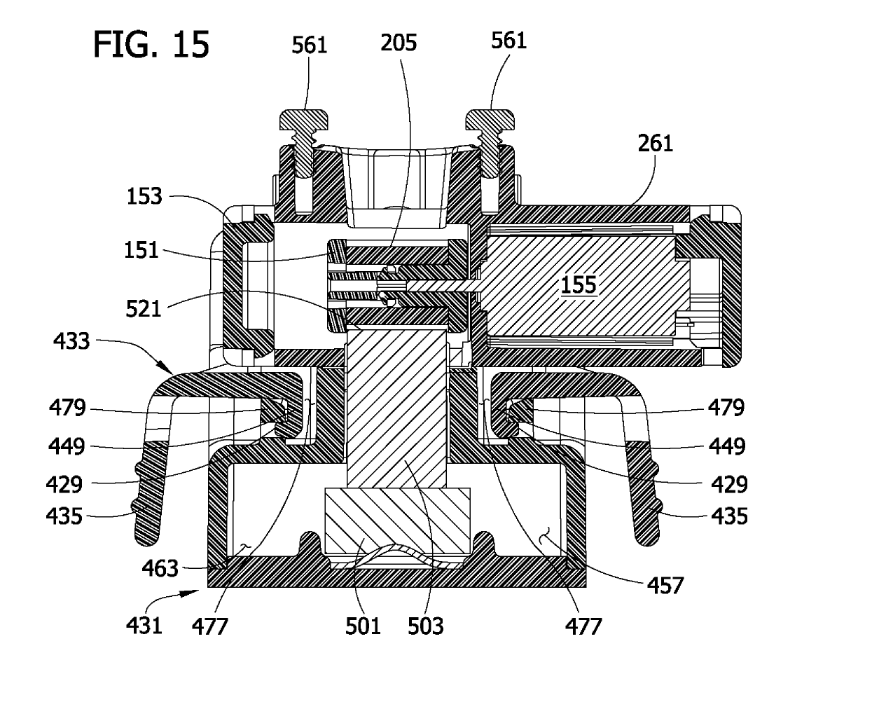

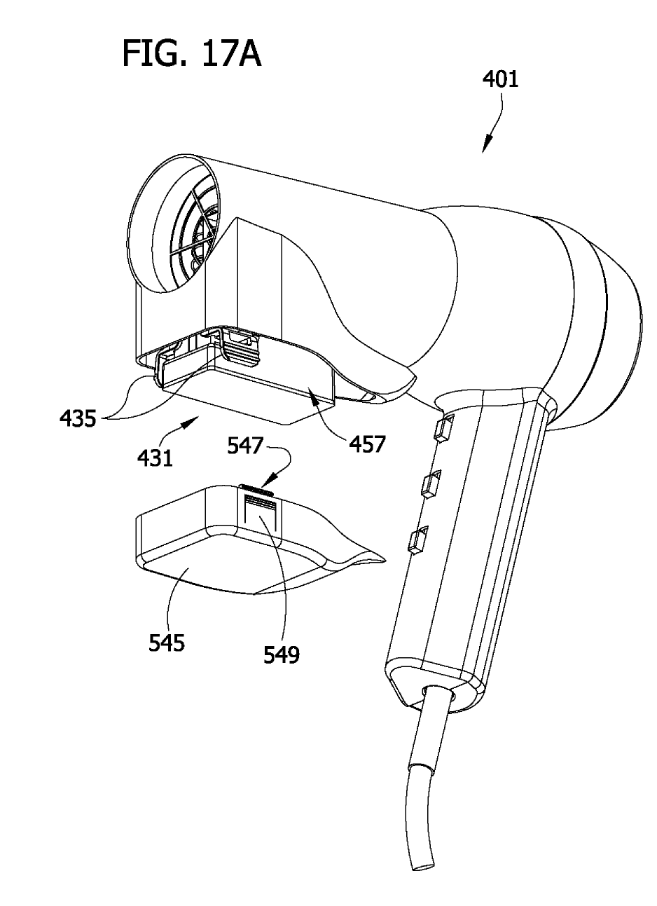

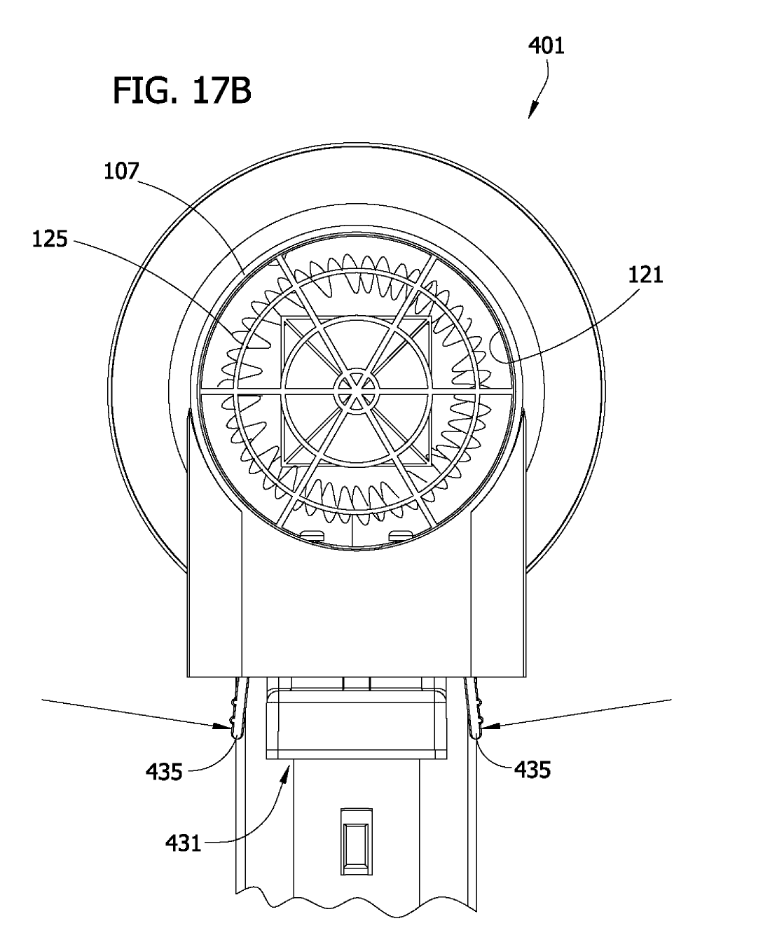

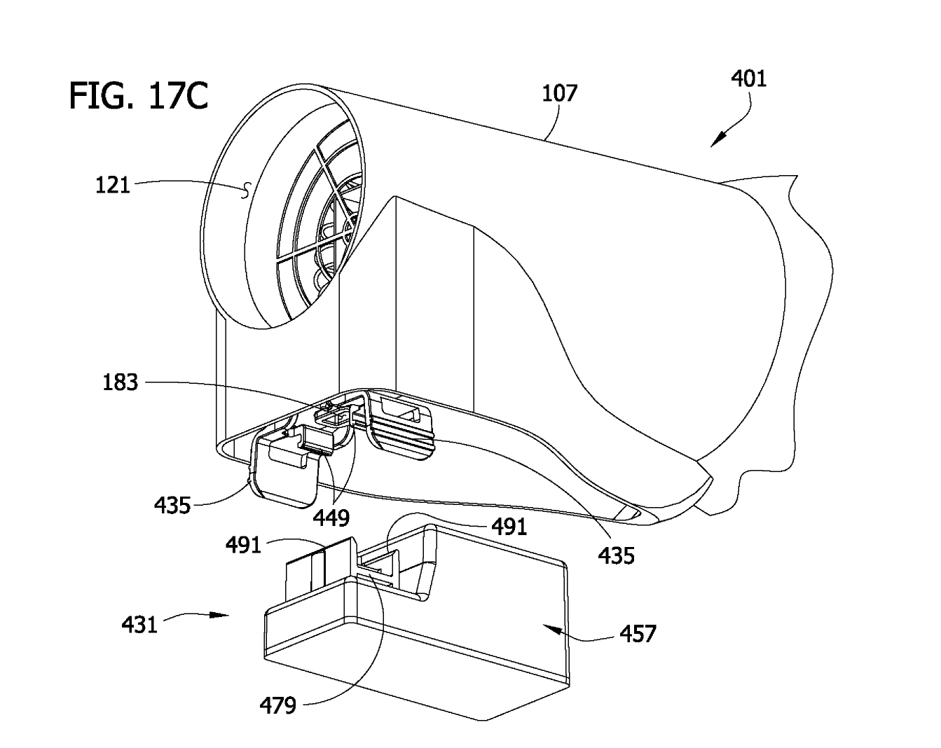

An L-shaped retaining member 449 (FIGS. 15 and 17C) extends from the lower portion of each jaw 435. The L-shaped retaining members 449 are oriented so they have free ends which extend away from one another in generally opposite directions. The reservoir 457 defines a pair of L-shaped recesses 477 on opposite sides of the reservoir outlet 481 at the top of the tongue portion 463 of the reservoir. Each recess 477 is defined in part by a detent bar 479 that is spaced laterally outward of the respective L-shaped recess 477.

The L-shaped recesses 477 are positioned and arranged to receive the L-shaped retaining members 449 of the jaws 435 when the lower portions of the jaws are squeezed toward one another against the bias of the biasing members 437. The recesses 477 are also shaped and arranged so that the ends 429 of the L-shaped retaining members 449 can slide under the respective detent bar 479 after the retaining members are inserted into the recesses. When the retaining members 449 of the jaws 435 are inserted into the recesses 477 in this manner the retaining members engage the side and bottom of each detent bar 479 and secure the reservoir 457, and therefore the cartridge 431, to the drum and motor housing 153, 261. When the cartridge 431 is secured to the hair dryer 401 in this manner, the drum wick 503 is positioned so that its contact end 521 extends into the drum housing 153 through the inlet opening 183 therein and contacts the drum 151. The biasing members 437 bias the jaws 435 so that the ends 429 of the retaining members 449 are urged to remain in the L-shaped recesses 477 and to remain in engagement with the detent bars 479. A user can release the cartridge 431 from the drum motor housing 153 by squeezing the lower portions of the jaws 435 together to disengage the L-shaped retaining members 449 from the detent bars 479 and then remove the retaining members from the L-shaped recesses 477, thereby releasing the cartridge from the hair dryer 401.

The reservoir 457 also suitably defines a pair of stops 491 on opposite sides of the reservoir outlet 481. These stops 491 engage the drum and motor housing 153, 261 when the cartridge 431 is secured to the hair dryer 401 to limit the extent to which the reservoir 457 can move up toward the drum and motor housing and to maintain desired spacing between the cartridge 431 and the drum 151.

Except for the reservoir outlet 481, which is plugged by the drum wick 503, the reservoir 457 is suitably substantially sealed in this embodiment. That is, there is no refill port or vent in the main portion 461 of the reservoir. The reservoir wick 501 does not substantially fill the reservoir 457. Instead, the reservoir wick 501 is a generally rectangular slab of wicking material extending along the bottom of the reservoir 457 from the tongue portion 463 of the reservoir into the main portion 461 of the reservoir. In this embodiment, leakage of the liquid from the reservoir outlet 481 is controlled by blocking the outlet with the drum wick 503. Reducing the number of openings into the reservoir 457 reduces evaporative losses of the hair treatment liquid 105 to provide longer shelf life for the cartridge 431. Further, the reservoir outlet 481 may be sealed at a manufacturing facility with a foil pull tab (not shown) releasably secured to the cartridge 431 (e.g., by an adhesive suitable for allowing a consumer to remove the pull tab before using the cartridge) in position to cover the outlet to increase shelf life and protect against unauthorized tampering with the contents of the cartridge. Reducing the volume of the reservoir wick 501 allows the reservoir 457 to hold a larger supply of hair treatment liquid 105 in the same size reservoir.

The drum wick 503 and reservoir wick 501 are suitably made of the same materials described above in relation to the wicking members 203, 201 of the hair dryer 101. The reservoir wick 501 contacts the drum wick 503 within the tongue portion of the reservoir 463 and the drum wick extends from the reservoir wick through the reservoir outlet 481 into contact with the drum outer surface 205 at the contact end 521 of the drum wick. The reservoir wick 501 is suitably biased to urge the contact end 521 of the drum wick 503 against the drum outer surface 205.

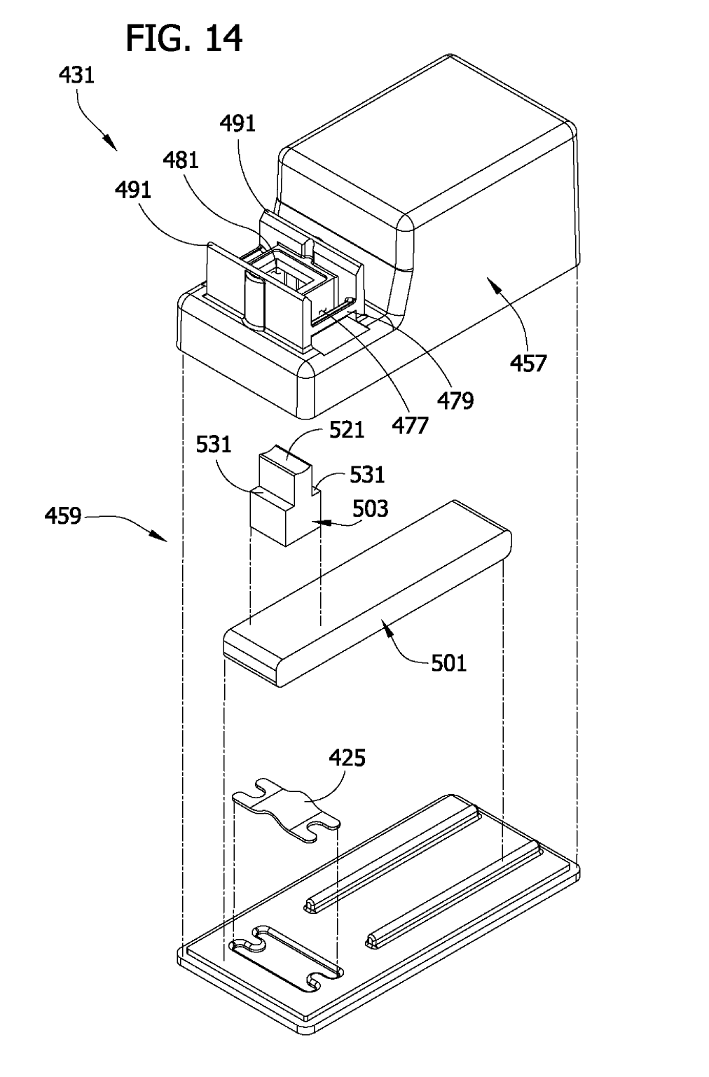

For example, in the embodiment of FIG. 14, a short spring clip 425 (broadly a biasing member) is positioned beneath the reservoir wick 501 in the tongue portion 463 of the reservoir 457. The apex of the spring clip 425 is spaced away from the bottom of the reservoir 457 when the spring clip 425 is in its relaxed state. The spring clip 425 is resiliently deformable to a configuration in which the apex of the spring clip 425 is closer to the bottom of the reservoir 457 than it is in its relaxed state. When the cartridge 431 is secured to the hair dryer 401, the drum wick 503 engages the drum 151. The spring constant of the spring clip 425 is suitably selected to maintain contact pressure between the drum wick 503 and the drum 151 in the desired range, as discussed above.

In contrast to the drum wick 203 described above, the drum wick 503 of this embodiment suitably includes one or more stops 531 that limit the extent to which the drum wick can move outward of the reservoir 457. The stops 531 thereby keep the drum wick 503 from falling out of the cartridge 531 when it is not secured to the hair dryer 401. As illustrated in FIG. 14, for example, the stops 531 are suitably a pair of shoulders extending laterally from opposite sides of the lower portion of the drum wick 503. The shoulders 531 of the drum wick 503 are too large to fit in the reservoir outlet 481. Upon sufficient movement of the drum wick 503 outward relative to the reservoir outlet 481, the shoulders 531 engage the reservoir containment structure 533 and thereby limit movement of the drum wick farther out of the reservoir 457. When the cartridge 431 is not secured to the hair dryer 401, the spring clip 425 suitably urges the reservoir wick 501 to move toward the drum wick 503, thereby urging the drum wick up until the shoulders 531 of the drum wick engage the reservoir containment structure 533.

When the cartridge 431 is secured to the hair dryer 401, the drum 151 may press the drum wick 503 inward, resiliently deforming the spring clip 425 in the reservoir 457. As the wick 503 is worn down by contact with the rotating drum 151, the spring clip 425 gradually returns toward its relaxed configuration, thereby maintaining the desired contact pressure between the drum wick and the drum 151. Because, the drum wick 503 is replaced along with the reset of the cartridge 431, the cartridge only has to be designed to accommodate the wear that the drum wick will incur during the life of the cartridge. Consequently, a biasing member having reduced travel (“travel” being used to refer to the distance traversed by the pertinent part of the biasing member as the biasing member is deformed from its relaxed state) may suffice in a cartridge based system. For example, the spring clip 425 in the cartridge 431 suitably has less travel than the leaf spring 225 described above and is suitably advantageously made from less material.

An outer cover 545 is releasably secured to the barrel 107 of the hair dryer 401 of this embodiment to substantially enclose the sprayer 403. For example, the outer cover 545 suitably encloses the entire sprayer 403 including the motor 155, the drum 151, the drum and motor housing 153, 261, the cartridge 431, and the latch system 433 securing the cartridge to the drum and motor housing. As illustrated in FIG. 11, for example, the outer cover 545 may be contoured as desired to give the hair dryer 401 a pleasing aesthetic look. The outer cover 545 illustrated in the drawings includes a user actuated latch mechanism 547, allowing the user to release the cover by squeezing release buttons 549 on opposite sides of the barrel 107. However, other systems for securing the outer cover to the hair dryer (e.g., slide on cover and snap on covers) are contemplated to be within the scope of this invention. An opening 551 in the outer cover 545 is aligned along the path of the sprayed droplets 291 with the sprayer outlet 145 to allow the spray droplets to exit the outer cover. The sprayer outlet 145 is suitably positioned in close proximity to the opening 551 in the outer cover 545. The opening 551 in the outer cover 545 is suitably slightly larger than the sprayer outlet 145 to minimize collisions of droplets 291 with the cover.

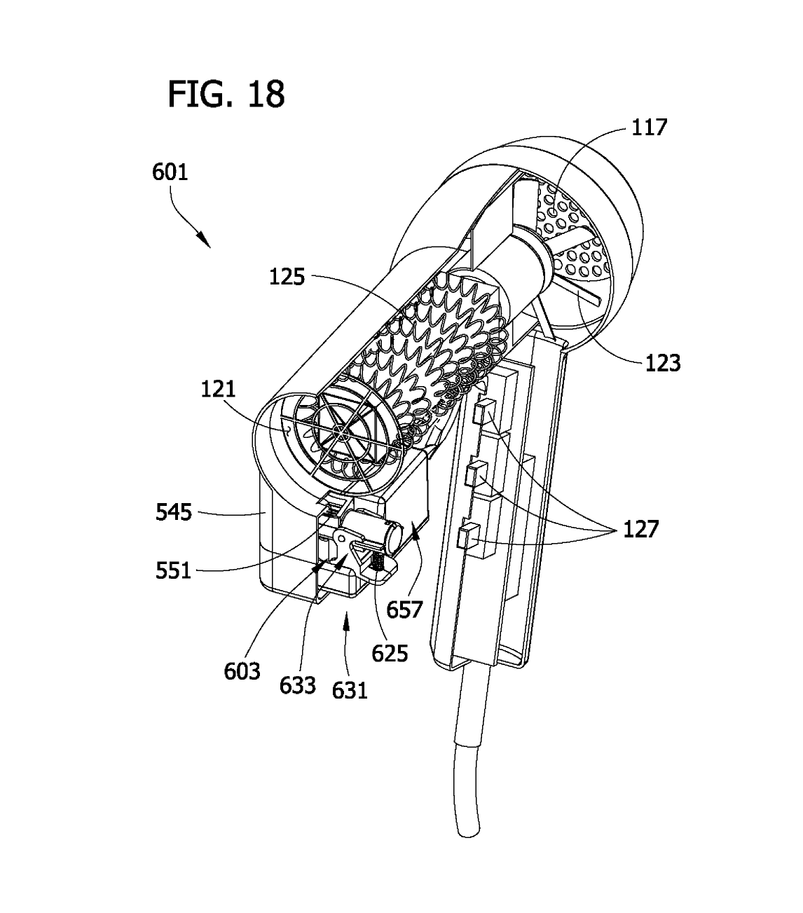

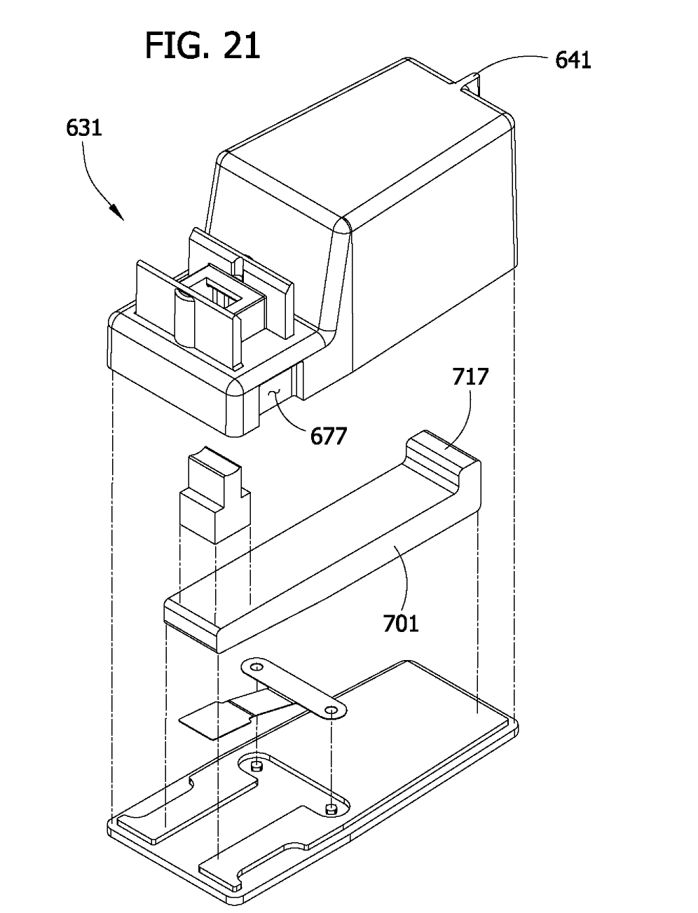

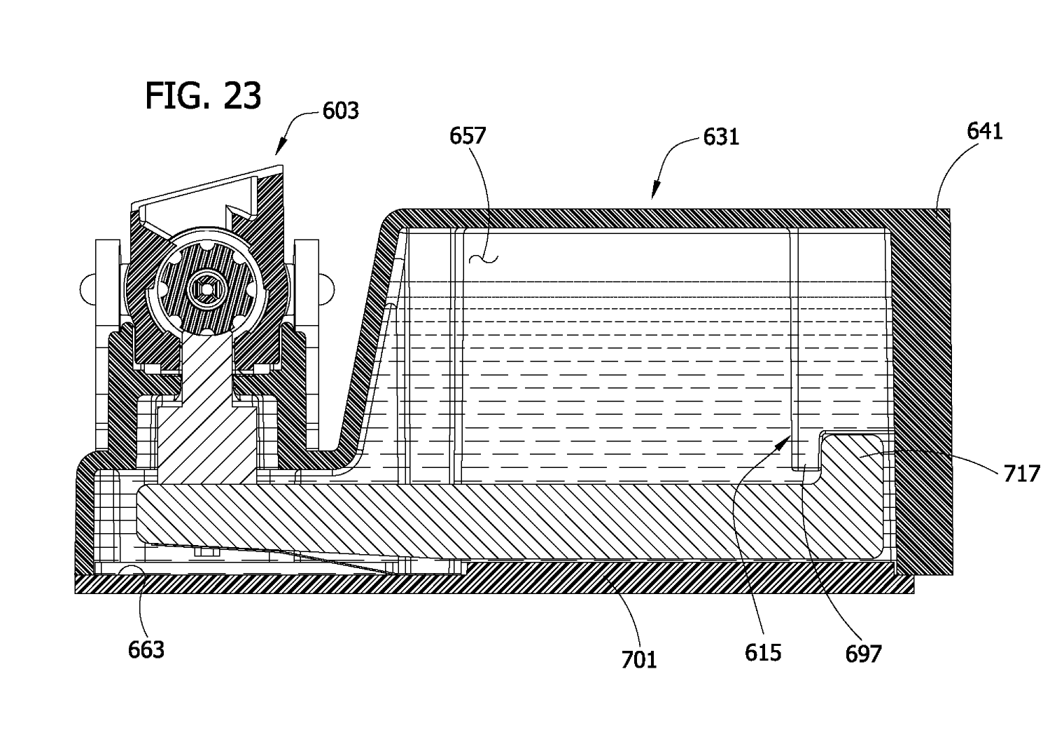

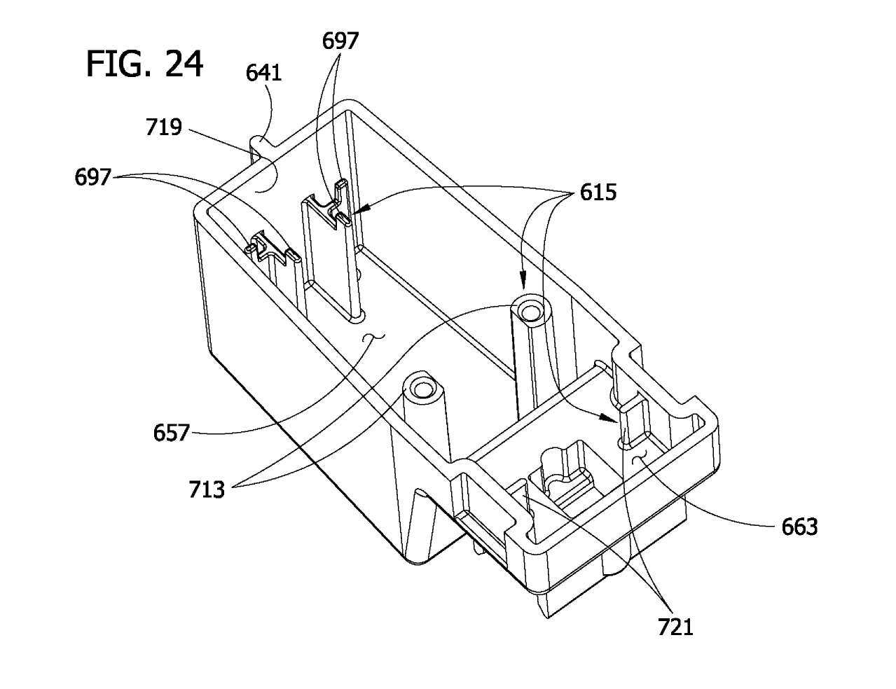

FIGURES. 18-24 illustrate yet another embodiment of a personal care appliance, again in the form of a hair dryer, generally designated 601, having a sprayer 603. Except as noted, this hair dryer 601 is constructed and operated in substantially the same way as the hair dryer 401 described above.

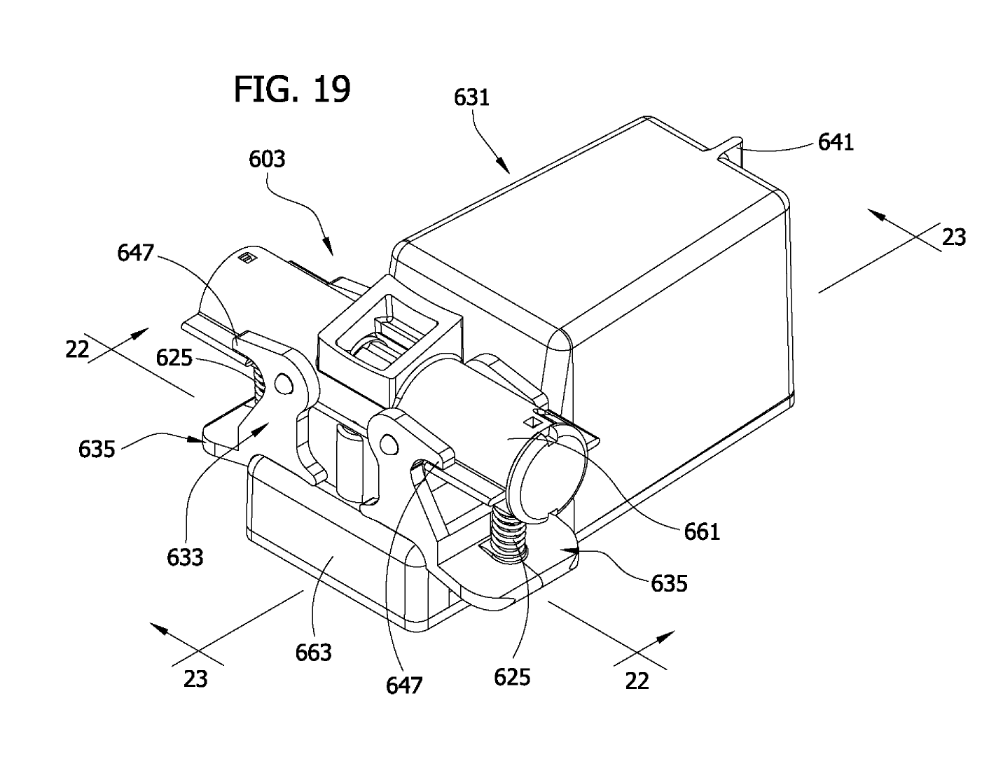

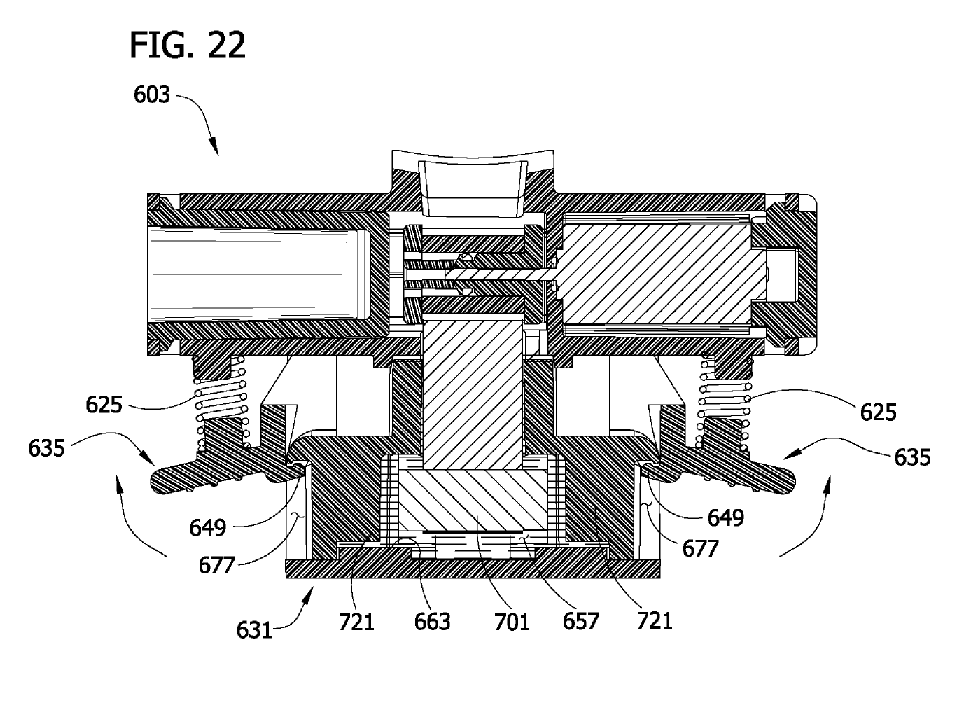

One difference is that the hair dryer 601 of this embodiment has a different latch system 633 than the latch system 433 described above. For example, the jaws 635 of the latch system 633 and cartridge 631 are configured so that the cartridge is released from the latch system by pivotal movement of the jaws in the opposite direction compared to the movement used to release the cartridge from the latch system 433 described above. Each jaw 635 has a retaining member 649 (FIG. 22) extending generally toward the opposite jaw. A pair of recesses 677 are defined in the exterior of the cartridge 631 on opposite sides of the tongue portion 663 of the reservoir 657. The retaining members 649 extend into the recesses 677 when the cartridge 631 is retained by the latch system 633, as illustrated in FIG. 19.

The jaws 635 are biased by biasing members 625 (e.g., springs compressed between the end of the jaw and the motor housing 661, as illustrated in FIG. 19) to move toward (and remain in) a retaining position. When the jaws 635 are in the retaining position the retaining members 649 are positioned to be received in the recesses 677 and prevent movement of the cartridge 631 away from the motor housing 661. The jaws 635 also include stops 647 on the upper ends of the jaws. The stops 647 engage fins 689 on the drum and motor housing 661 to limit rotation of the jaws 635 that may be produced by the biasing members 625. The jaws 635 are moveable from their retaining position against the bias of the biasing members 625 to a release position. To release the cartridge 631 a user rotates the jaws 635 against the bias (in the direction of the arrows on FIG. 22), thereby withdrawing the retaining members 649 from the recesses 677 to allow the cartridge 631 to separate and move away from the motor housing 661.

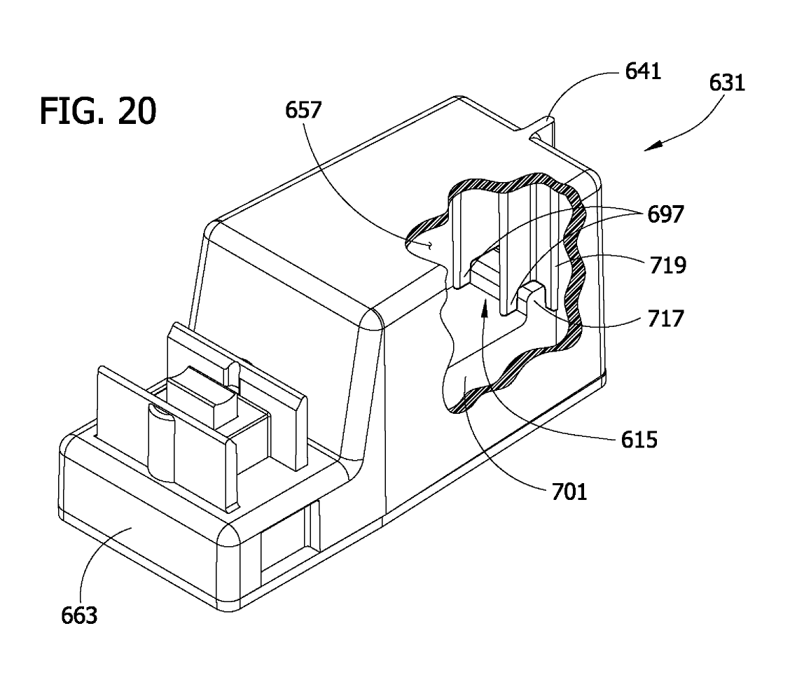

Another difference in the hair dryer 601 of this embodiment is that the cartridge 631 has a reservoir wick 701 retaining system 615 for limiting movement of the reservoir wick 701 in the reservoir 657. The reservoir wick 701 is shaped to have a raised portion 717 at the end of the reservoir wick opposite the tongue portion 663 of the reservoir 657. At least one wick retainer 697 is secured to the inside of the reservoir 657 adjacent the raised portion 717 of the reservoir wick 701 so that the retainer limits movement of the reservoir wick in the reservoir. As best seen in FIGS. 20, 23 and 24, the retaining system 615 illustrated in the drawings comprises four wick retainers 697 configured to engage the raised portion 717 of the reservoir wick 701 on three different sides of the raised portion of the wick. The fourth side of the raised portion 717 of the reservoir wick 701 is engaged by the rear wall 719 of the reservoir 657, resulting in the raised portion of the reservoir wick being supported on all four of its sides. The wick retaining system 615 also includes two posts 713 in the reservoir positioned to be alongside a middle portion of the reservoir wick 701. The posts 713 limit side-to-side movement of the middle of the wick 701 in the reservoir 657. The wick retaining system also includes a pair of fins 721 extending in from the sides of the tongue portion 663 of the reservoir 657. As best seen in FIG. 22, the fins 721 are on opposite sides of the end of the reservoir wick 701 extending into the tongue portion 663 of the reservoir 657 and limit side-to-side movement thereof in the reservoir.

The cartridge 631 has a vertical alignment fin 641 extending substantially perpendicularly from the back of the reservoir 657. The alignment fin is configured to be received in a corresponding alignment slot (not shown) in the housing of the hair dryer 601 to help ensure and maintain the desired alignment between the cartridge 631 and the rest of the hair dryer.

When introducing elements of the present invention or the preferred embodiments thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions and methods without departing from the scope of the invention, it is intended that all matter contained in the above description and illustrated in the accompanying drawings shall be interpreted as illustrative and not in a limiting sense.

What is claimed is:

1. A hand held hair dryer comprising:
an air duct having an air inlet and an air outlet;
a fan unit operable to draw air into the duct at said air inlet and directing the air flow to the air outlet for exhaustion from the hair dryer; and
a hair treatment liquid delivery system for delivering a hair treatment liquid from the hair dryer, said delivery system comprising:
a reservoir configured for containing a supply of hair treatment liquid;
a rotatable drum having a surface in fluid communication with the reservoir for receiving hair treatment liquid onto the surface of the drum; and
a drive system operable to rotate the drum such that hair treatment liquid is thrown from the drum by centrifugal force of the rotating drum for delivering hair treatment liquid from the hair dryer in the form of a spray of droplets.

2. The hair dryer set forth in claim 1, in combination with the supply of hair treatment liquid.

3. The hair dryer set forth in claim 1, wherein the surface is an outer surface of the drum.

4. The hair dryer set forth in claim 3, wherein the drum is generally cylindrical and has a longitudinal axis, the drum outer surface having a plurality of at least one of grooves and ridges extending longitudinally thereon and spaced circumferentially from one another about the drum

5. The hair dryer set forth in claim 3 wherein the drum is generally cylindrical and has a longitudinal axis, the drum outer surface having a plurality of longitudinally extending grooves therein, the grooves being spaced circumferentially from one another about the drum.

6. The hair dryer set forth in claim 1 wherein the hair treatment liquid delivery system further comprises a drum housing, the drum being disposed within the housing with the outer surface of the drum in fluid communication with the reservoir, said housing having an opening through which liquid thrown from the drum outer surface upon rotation of the drum exits the hair dryer in the form of a spray of droplets.

7. The hair dryer set forth in claim 6 wherein the opening of the housing is positioned relative to the air duct of the hair dryer such that hair treatment liquid exiting the drum housing at said drum housing opening becomes entrained in the air flow of the hair dryer.

8. The hair dryer set forth in claim 5 wherein the air flow is in an air flow direction at said air outlet of the air duct, the spray of droplets of hair treatment liquid being thrown outward through the opening in the drum housing generally at an angle relative to the air flow direction in the range of about 5 degrees to about 40 degrees.

9. The hair dryer set forth in claim 7 wherein the hair treatment liquid delivery system is disposed exterior of the air duct, the opening of the drum housing being disposed generally adjacent the air outlet of said air duct for entraining hair treatment liquid in the air flow generally as air exits the air duct.

10. The hair dryer set forth in claim 9 further comprising a cover releasably attachable to the dryer to substantially enclose the hair treatment liquid delivery system.

11. The hair dryer set forth in claim 1 further comprising a liquid transfer system for transferring the hair treatment liquid from the reservoir to the drum, the liquid transfer system comprising a first wicking member disposed in the reservoir free from contact with the drum and constructed to hold hair treatment liquid in the reservoir, and a second wicking member in fluid communication with the first wicking member to receive hair treatment liquid from the first wicking member, said second wicking member being in contact with the drum at least during rotation of the drum for transferring hair treatment liquid onto the surface of the drum.

12. The hair dryer set forth in claim 11 wherein a portion of the second wick in contact with the drum is shaped to correspond generally to the surface of the drum.

13. The hair dryer set forth in claim 11 wherein a contact pressure of said portion of the second wick against the drum outer surface is in the range of about 0.085 grams square millimeter to about 0.4 grams square millimeter.

14. The hair dryer set forth in claim 13 wherein the contact pressure of the second wick against the drum is selectively adjustable.

15. The hair dryer set forth in claim 11 wherein the reservoir has a total volumetric capacity, said first wick taking up at least about 80 percent of the total volumetric capacity of the reservoir.

16. The hair dryer set forth in claim 11 wherein the second wick is in direct contact with the first wick.

17. The hair dryer set forth in claim 11 wherein the second wick is at least in part disposed in the reservoir.

18. The hair dryer set forth in claim 11 wherein the drum is disposed exterior of the reservoir, the reservoir having an opening therein, the second wick being disposed in said opening in contact with the drum.

19. The hair dryer set forth in claim 1 wherein the drum is generally cylindrical and has a longitudinal axis, the drum further comprising a pair of flange members spaced longitudinally from each other and each extending radially outward from the drum, the hair dryer further comprising a liquid transfer system operable to transfer hair treatment liquid from the reservoir to the drum between the flange members.

20. The hair dryer set forth in claim 1 wherein the hair treatment liquid delivery system is secured to the hair dryer, the reservoir being releasably attached to the hair dryer to permit refilling or replacement of the reservoir.

21. The hair dryer set forth in claim 20 further comprising a liquid transfer system for transferring hair treatment liquid from the reservoir to the drum, wherein the reservoir and liquid transfer system are components of a cartridge that is releasably attached to the hair dryer to permit refilling or replacement of the cartridge.

22. The hair dryer set forth in claim 1 wherein the hair treatment liquid is sprayed from the hair treatment liquid delivery system at a spray rate, said spray rate being selectively adjustable.

23. The hair dryer set forth in claim 22 wherein the spray rate is adjustable by at least one of (i) a system operable to change the rotation rate of the drum and (ii) a moveable shield that is selectively moveable by a user to block a portion of the spray coming off of the drum outer surface.

24. A liquid sprayer comprising:
a reservoir containing a supply of a liquid;
a generally cylindrical drum having a longitudinal axis and being rotatable on said axis, said drum having an outer surface and a pair of flange members spaced longitudinally from each other and each extending radially outward from the drum outer surface;
a drive system operable to rotate the drum on said longitudinal axis;
a liquid transfer system operable to transfer liquid from the reservoir to the drum outer surface between the flange members whereby upon rotation of the drum on its longitudinal axis liquid is thrown from the outer surface of the drum by centrifugal force of the rotating drum for delivering liquid from the sprayer in the form of a spray of droplets.

25. The sprayer set forth in claim 24 wherein the drum outer surface has at least one groove formed therein and extending longitudinally between the flange members.

26. The sprayer set forth in claim 25 wherein the drum outer surface has a plurality of grooves formed therein and extending longitudinally between the flange members in circumferentially spaced relationship with each about the drum outer surface.

27. The sprayer set forth in claim 24 wherein the sprayer is configured to generate a substantially rectangular spray pattern.

28. The sprayer set forth in claim 24 wherein the liquid is a hair treatment liquid comprising at least one of a conditioner, a shine enhancer, a de-tangler, a hair styling liquid, a heat protectant, and an ion solution.

29. The sprayer set forth in claim 24 in combination with a hair care appliance, the sprayer being secured to the hair care appliance, the liquid being a hair treatment liquid whereby the sprayer is operable to deliver a spray of said hair treatment liquid from the hair care appliance.

30. A liquid sprayer comprising:
a reservoir containing a supply of liquid;
a rotatable drum having an outer surface in fluid communication with the reservoir for receiving liquid from the reservoir onto the outer surface of the drum;
a liquid transfer system in fluid communication with the reservoir to transfer liquid out of the reservoir and onto the drum outer surface, said liquid transfer system comprising a first wicking member disposed in the reservoir and constructed to hold liquid in the reservoir, and a second wicking member in fluid communication with the first wicking member to receive liquid from the first wicking member, said second wicking member being in contact with the drum outer surface for transferring liquid onto the drum outer surface, the second wicking member being positioned intermediate the drum and the first wicking member; and
a drive system operable to rotate the drum such that liquid is thrown from the drum outer surface by centrifugal force of the rotating drum for delivering liquid from the sprayer in the form of a spray of droplets.

31. The sprayer set forth in claim 30 wherein a portion of the second wick in contact with the drum outer surface is shaped to correspond generally to a portion of the drum outer surface.

32. The sprayer set forth in claim 30 wherein a contact pressure of said portion of the second wick against the drum outer surface is in the range of about 0.085 grams square millimeter to about 0.4 grams square millimeter.

33. The sprayer set forth in claim 32 wherein the contact pressure of the second wick against the drum outer surface is selectively adjustable.

34. The sprayer set forth in claim 30 wherein the reservoir has a total volumetric capacity, said first wick taking up at least about 80 percent of the total volumetric capacity of the reservoir.

35. The sprayer set forth in claim 30 wherein the second wick is in direct contact with the first wick.

36. The sprayer set forth in claim 30 wherein the second wick is at least in part disposed in the reservoir.

37. The sprayer set forth in claim 30 wherein the drum is disposed exterior of the reservoir, the reservoir having an opening therein, the second wick being disposed in said opening in contact with the drum outer surface.

38. The sprayer set forth in claim 30 in combination with a hair care appliance, the sprayer being secured to the hair care appliance, the liquid being a hair treatment liquid whereby the sprayer is operable to deliver a spray of said hair treatment liquid from the hair care appliance.

39. The sprayer set forth in claim 30, wherein the first and second wicking members are formed separately.

40. A method of using a hand held appliance to dry and apply a hair treatment liquid to a subject's hair, the method comprising:
directing an air stream emitted from an air outlet of the appliance onto the subject's hair to dry the hair; and
spraying droplets of the hair treatment liquid onto the subject's hair from a spray outlet of the appliance, the spraying being conducted so that the droplets produce a generally rectangular spray pattern on the subject's hair, the spray pattern having a length and a width, the length being greater than the width, the spraying further being conducted so that the distribution density of droplets along the length of the spray pattern is substantially uniform, the spraying further comprising moving the appliance so that the spray pattern translates over the subject's hair in a direction including a component parallel to the width of the spray pattern.

41. A method as set forth in claim 40, wherein the spraying comprises rotating a drum such that liquid is thrown from the drum outer surface by centrifugal force of the rotating drum.

42. A method as set forth in claim 41, wherein the drum has a pair of flange members spaced longitudinally from each other and each extending radially outward from the drum outer surface, the spraying including transferring liquid to be sprayed to the drum outer surface between the flanges.

43. A method as set forth in claim 42, wherein the transferring of the liquid comprises wicking the liquid through a wick to the drum outer surface.

44. A method as set forth in claim 43, wherein the wick is a first wick, the method further comprising wicking the liquid through a second wick to the first wick.

45. A hand held hair dryer operable to deliver a hair treatment liquid from a supply of said liquid, said hair dryer comprising:
an air duct having an air inlet and an air outlet;
a fan unit operable to draw air into the duct at said air inlet and directing the air flow to the air outlet for exhaustion from the hair dryer; and
a sprayer comprising a rotatable drum having a surface adapted for receiving a hair treatment liquid from said supply of hair treatment liquid onto the surface of the drum and a drive system operable to rotate the drum such that the hair treatment liquid can be thrown from the drum by centrifugal force of the rotating drum for delivering the hair treatment liquid from the hair dryer in the form of a spray of droplets.

46. The hand held hair dryer set forth in claim 45, further comprising a cartridge releasably secured to the hair dryer, the cartridge defining a reservoir for containing a supply of the hair treatment liquid.

47. The hand held hair dryer set forth in claim 46, further comprising the hair treatment liquid in the reservoir.

48. A cartridge for use with a hair dryer, the hair dryer having a sprayer operable to spray a hair treatment liquid from the hair dryer, said cartridge comprising a container configured for containing hair treatment liquid and a wick disposed at least in part in the container for delivering hair treatment liquid from the container to the sprayer, the cartridge being releasably securable to the hair dryer to supply the sprayer with hair treatment liquid from the container via the wick.
